(19) United States
(12) Patent Application Publication
(10) Pub. No.: US 2008/0271035 A1
(43) Pub. Date: Oct. 30, 2008

(54) Control Device and Method for Multiprocessor

(75) Inventor: Hideki Yasukawa, Fujisawa-shi (JP)

Correspondence Address: SPRINKLE IP LAW GROUP, 1301 W. 25TH STREET, SUITE 408, AUSTIN, TX, 78705, US

(73) Assignee: KABUBHIKI KAISHA TOSHIBA, Tokyo (JP)

(21) Appl. No.: 12/109,391

(22) Filed: Apr. 25, 2008

(30) Foreign Application Priority Data
Apr. 25, 2007 (JP) 2007-116167

(51) Int. Cl. G06F 9/46

(52) U.S. Cl. 718/104

(57) ABSTRACT

An multiprocessor control device according to an example of the invention comprises a selection unit which, on the basis of an execution schedule for tasks to be allocated to any one of processor elements, selects, for each of the processor elements, any one of a normal mode used in a task execution time, a first mode which is used when a task is not executed and in which a power consumption is reduced more than in the normal mode, and a second mode which is used when the task is not executed and which has a greater power consumption reducing effect but a longer mode switching time than the first mode, and a mode control unit which performs control according to the mode selected by the selection unit for each of the processor elements.

### CROSS-REFERENCE TO RELATED APPLICATIONS

This application is based upon and claims the benefit of priority from prior Japanese Patent Applications No. 2007-116167, filed Apr. 25, 2007, the entire contents of which are incorporated herein by reference.

### BACKGROUND OF THE INVENTION

1. Field of the Invention

This invention relates to a multiprocessor control device and a multiprocessor control method for decreasing the electric power consumption in a multiprocessor architecture.

2. Description of the Related Art

In the recent microprocessor, the calculating performance tends to be improved by increasing the number of processor elements rather than increasing the frequency.

In a multiprocessor with a plurality of processor elements, it is desirable that the electric power consumption should be suppressed to low levels.

Processor element monitoring control means capable of controlling the electric power consumption in a plurality of processor elements arranged on a chip according to the processing state of the jobs allocated to the respective processor elements has been disclosed in patent document 1 (Jpn. Pat. Appln. KOKAI Publication No. 2004-240669).

An invention for monitoring the instruction execution state of the instruction execution control unit and, when a specific continuous time of halting state has been detected at the instruction idle counter, causing the clock distribution control unit to stop the clock in the processor has been disclosed in patent document 2 (Jpn. Pat. Appln. KOKAI Publication No. 2004-112559).

An invention for causing the multitask operating system to monitor the utilization volume of each CPU and stop or suspend a CPU whose utilization volume is small has been disclosed in patent document 3 (Jpn. Pat. Appln. KOKAI Publication No. 11-202988).

An invention for calculating an increase or decrease in the number of tasks to be processed by parallel CPs according to the increase or decrease of the standby time, determining the number of CPs to be actually processed in parallel, and turning off the operating power supply of the remaining CPs has been disclosed in patent document 4 (Jpn. Pat. Appln. KOKAI Publication No. 6-309288).

An invention for causing the microprocessor on standby to output a BUSY signal and switch to a clock in the standby mode has been disclosed in patent document 5 (Jpn. Pat. Appln. KOKAI Publication No. 4-88515).

Not all applications have a high degree of parallelism. If an application with a low parallelism is executed on a multiprocessor, an idle time during which a large number of processor elements mounted on the chip do not execute processes tends to increase. In this case, the entire multiprocessor wastes electric power and generates heat, which is a problem.

Conventionally, there has been known a technique configured to attach a device having a calculation function to an information processing device and cause the attached device to share a part of a process to be executed. For example, there is a technique in which the device having the calculation function, which is called “accelerator”, is mounted in a personal computer (hereinafter referred to as “PC”) as the information processing device and a Central Processing Unit (hereinafter referred to as “CPU”) in a body of the PC causes the accelerator to share the process of a program, with an intention of improving a processing speed.

Recently, an information processing device having the accelerator attached to its body unit, not only with an intention of sharing the process or improving the processing speed, but also in consideration of electric power consumption, has also been proposed, for example, in Japanese Patent Laid-Open No. 2003-15785.

According to a technique according to the proposition, the CPU at the body unit side reads performance information on the attached accelerator, and based on the performance information, determines and sets a driving voltage or a driving frequency for the accelerator, which enables the accelerator to be driven correspondingly to a low power consumption mode and the like.

However, in the case of the information processing device according to the above described proposition, since the CPU at the body unit side determines the driving voltage and the like for the accelerator, the CPU has to execute a determination process thereof, causing an overhead in the CPU.

Moreover, the information processing device according to the above described proposition has not considered such a case where there are multiple calculation units within the accelerator.

### BRIEF SUMMARY OF THE INVENTION

A multiprocessor control device according to an example of the invention comprises a selection unit which, on the basis of an execution schedule for a plurality of tasks to be allocated to any one of a plurality of processor elements, selects, for each of the plurality of processor elements, any one of a normal mode used in a task execution time, a first mode which is used when a task is not executed and in which an electric power consumption is reduced more than in the normal mode, and a second mode which is used when the task is not executed and which has a greater electric power consumption reducing effect but a longer mode switching time than the first mode, and a mode control unit which performs control according to the mode selected by the selection unit for each of the plurality of processor elements.

### BRIEF DESCRIPTION OF THE SEVERAL VIEWS OF THE DRAWING

FIG. 1 is a block diagram showing an example of a multiprocessor which includes a control processor element of a first embodiment;

FIG. 2 is a flowchart showing an example of an operation of the control processor element according to the first embodiment;

FIG. 3 is a task flow graph showing an example of an application program to be executed by the multiprocessor according to the first embodiment;

FIG. 4 shows an example of electric power consumption suppression at the time of barrier synchronization in a Rest mode;

FIG. 5 shows an example of electric power consumption suppression at the time of barrier synchronization in a Sleep mode;

FIG. 6 is a block diagram showing the first modified example of the multiprocessor of the first embodiment;

FIG. 7 is a block diagram showing the second modified example of the multiprocessor of the first embodiment;

FIG. 8 is a view showing an example of a time required to switch modes and percentage of reducible electric power for the Rest mode and Sleep mode;

FIG. 9 shows an example of a task flow graph in a case where optimization is performed to concentrate tasks which need not be executed in parallel into a specific processor element and mode switching is not done;

FIG. 10 shows an example of a task flow graph in a case where optimization is performed to concentrate tasks which need not be executed in parallel into a specific processor element and mode switching is done;

FIG. 11 shows an example of a task flow graph in a case where a task arrangement hasn't been optimized and mode switching is done;

FIG. 12 is a block diagram showing an example of a multiprocessor which includes a control processor element of a third embodiment;

FIG. 13 is a table showing an example of a relationship between various modes, power supply/stop, clock supply/stop, clock frequency, and electric power supply voltage;

FIG. 14 is a configuration diagram showing a configuration of an information processing device according to a fourth embodiment of the present invention;

FIG. 15 is a block diagram illustrating a configuration of an accelerator according to the fourth embodiment;

FIG. 16 is a flowchart showing an example of a flow of a process in a CPU according to the fourth embodiment;

FIG. 17 is a diagram showing an example of table data showing load information and degree of parallelism information according to the fourth embodiment;

FIG. 18 is a flowchart showing an example of a process in a CPE according to the fourth embodiment;

FIG. 19 is a flowchart showing an example of a flow of a process of determining an operating frequency according to the fourth embodiment;

FIG. 20 is a flowchart showing an example of a flow of a process at the time of completing a processing program in a calculation unit of the CPE according to the fourth embodiment;

FIG. 21 is a diagram illustrating the process in the CPE according to the fourth embodiment;

FIG. 22 is a block diagram showing a configuration of an accelerator according to a fifth embodiment of the present invention;

FIG. 23 is a flowchart showing an example of a flow of a process in a CPU according to the fifth embodiment;

FIG. 24 is a diagram showing an example of table data showing load information and degree of parallelism information on a decoding process according to the fifth embodiment of the present invention; and

FIG. 25 is a flowchart showing an example of the decoding process in the CPE according to the fifth embodiment.

### DETAILED DESCRIPTION OF THE INVENTION

Hereinafter, referring to the accompanying drawings, embodiments of the invention will be explained. Parts that realize the same functions are indicated by the same reference numerals throughout the drawings and an explanation of them will be omitted.

### First Embodiment

In a first embodiment of the invention, a control processor element (control unit) which schedules tasks and switches between a normal mode, a Rest mode, and a Sleep mode for each of processor elements in a multiprocessor that has a plurality of the processor elements mounted on a single chip will be explained.

In the first embodiment, an electric power consumption of the processor elements is suppressed in two stages: the Rest mode and Sleep mode.

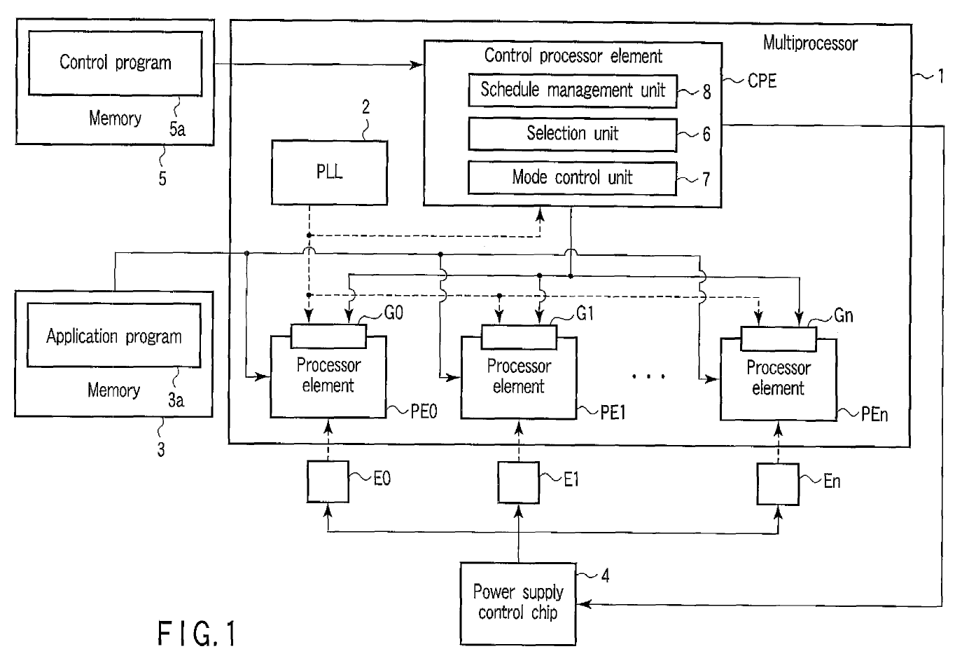

FIG. 1 is a block diagram showing an example of a multiprocessor which includes a control processor element of the first embodiment.

A multiprocessor 1 has a plurality of processor elements PE₀ to PEₙ on a single chip. The multiprocessor 1 further includes a PLL (Phase Locked Loop) 2 for generating a clock signal and a control processor element CPE.

The processor elements PE₀ to PEₙ execute an application program 3a stored in a memory 3.

The processor elements PE₀ to PEₙ are provided with clock gates G₀ to Gₙ, respectively, each of which goes into an ON state when the clock is supplied and into an OFF state when the supply of the clock is stopped.

Power-supply modules E₀ to Eₙ supply electric powers to the processor elements PE₀ to PEₙ, respectively.

A power supply control chip 4 switches between ON and OFF of the power supply modules E₀ to Eₙ according to an instruction from the control processor element CPE.

The first embodiment will be explained taking as an example a case where the power supply modules E₀ to Eₙ are caused to correspond to the processor elements PE₀ to PEₙ, respectively.

The control processor element CPE executes a control program 5a stored in a memory 5 and functions as a schedule management unit 8, a selection unit 6, and a mode control unit 7.

The schedule management unit 8 manages a job input schedule for the processor elements PE₀ to PEₙ. The schedule management unit 8 adjusts a task execute schedule so that, of a plurality of tasks, the ones which need not be executed in parallel may be preferentially allocated to specific one of the processor elements PE₀ to PEₙ.

The selection unit 6 selects any one of the normal mode, Rest mode, and Sleep mode for each of the processor elements PE₀ to PEₙ on the basis of an execution schedule for a plurality of tasks included in the application program 3a allocated to the processor elements PE₀ to PEₙ, respectively.

Here, the normal mode means a normal state in which a task is executed.

The Rest mode requires less time to switch the mode but is less effective in suppressing the electric power consumption. That is, the Rest mode is used during the time when no task is executed. In the Rest mode, the electric power consumption is suppressed more than in the normal mode.

The Sleep mode requires some time to switch the mode but has a great power consumption suppressing effect. That is, the Sleep mode is used when no task is executed and has a greater electric power consumption effect than the Rest mode. However, the Sleep mode requires a longer mode switching time than the Rest mode.

In the first embodiment, an explanation will be given about a case where the clock signal supply is stopped when the Rest mode is selected and the supply of electric power is stopped when the Sleep mode is selected. However, another electric power consumption suppressing method may be used, provided that the Rest mode and Sleep mode have the above-described relationship. As another electric power consumption suppressing method, for example, the suppression of power supply voltage, the suppression of frequency, or the application of back bias may be used.

Specifically, the selection unit 6 selects the normal mode for each of the processor elements PE₀ to PEₙ during the time when a task is executed.

Moreover, when the time from when the execution of a task is completed until the execution of the next task is started is within a preset Rest mode applicable time range for each of the processor elements PE₀ to PEₙ, the selection unit 6 selects the Rest mode during the time from when the execution of the task is completed until the execution of the next task is started.

Furthermore, when the time from when the execution of a task is completed until the execution of the next task is started exceeds the Rest mode applicable time range (or is within a Sleep mode applicable time range) for each of the processor elements PE₀ to PEₙ, the selection unit 6 selects the Sleep mode during the time from when the execution of the task is completed until the execution of the next task is started.

When selecting the Sleep mode, the selection unit 6 determines the execution time of the Sleep mode so that the execution time of the Sleep mode including the mode switching time (before and after the Sleep mode) needed to switch to the Sleep mode and the execution time of the Sleep mode may not exceed the time from when the execution of the task is completed until the execution of the next task is started.

Then, the selection section 6 selects the normal mode during the execution time of the next task for each of the processor elements PE₀ to PEₙ.

The mode control unit 7 performs control according to the mode selected by the selection unit 6 for each of the processor elements PE₀ to PEₙ.

Specifically, the mode control unit 7 gives a mode switching instruction to go into the OFF state to the clock gate of the processor element for which the Rest mode has been selected by the selection unit 6. After the processor element corresponding to the clock gate goes into a state where it executes no task, the clock gate goes into the OFF state according to the mode switching instruction. Moreover, the mode control unit 7 gives a mode switching instruction to go into the ON state to the clock gate of the processor element for which the Rest mode has been cancelled. The clock gate goes into the ON state according to the mode switching instruction.

As described above, by giving the clock gate a mode switching instruction to go into the OFF state, it is possible to decrease the clock power consumption in the processor element corresponding to the clock gate to zero.

Moreover, the mode control unit 7 gives the power supply control chip 4 a mode switching instruction including identification data of the processor element for which the Sleep mode has been selected by the selection unit 6, and the execution time of the determined Sleep mode.

After the processor element indicated by the mode switching instruction has executed no task, the power supply control chip 4 stops the power supply module corresponding to the processor element indicated by the mode switching instruction for the execution time of the Sleep mode shown by the mode switching instruction.

As described above, the power supply module corresponding to the processor element is turned off, thereby stopping the supply of power to the processor element, which enables the electric power consumption of the processor element to be decreased to zero.

Hereinafter, the multiprocessor in which the control processor element CPE configured as described above has been installed will be explained using a concrete example.

The multiprocessor 1 of the first embodiment 1 is a chip processor system which has a plurality of processor elements PE₀ to PEₙ of the order of, for example, several hundred MHz to several GHz on a single chip.

The multiprocessor 1 includes the control processor element CPE which manages the job input schedule for the processor elements PE₀ to PEₙ.

The control processor element CPE manages the job input schedule for the processor elements PE₀ to PEₙ. The control processor element CPE may be used in executing the application program 3a as may the other processor elements PE₀ to PEₙ.

A method of suppressing the electric power consumption in the multiprocessor 1 includes, for example, the suppression of power supply voltage, the suppression of frequency, clock supply stop, power supply stop, and the application of back bias.

The multiprocessor 1 sets two stages of power supply suppression mode for each of the processor elements PE₀ to PEₙ or in groups higher in level than the processor elements.

In the Rest mode, a power consumption suppression method is used which takes less time to change from the normal mode in which the processor elements PE₀ to PEₙ operate normally and return to the normal mode than in the Sleep mode but which has a smaller power consumption suppressing effect than in the Sleep mode.

In contrast, in the Sleep mode, a power consumption suppression method is used which takes a longer time to change from the normal mode and return to the normal mode than in the Rest mode but which has a greater power consumption suppressing effect in the Rest mode.

The control multiprocessor element CPE includes the selection unit 6 which, when instructing each of the processor elements PE₀ to PEₙ to execute a job, selects any one of the transition to the Rest mode, the transition to the Sleep mode, and no transition (stay in the normal node).

The mode control unit 7 can inform the processor elements PE₀ to PEₙ and power supply control chip 4 of a mode switching instruction with any timing. That is, the mode control unit 7 can issue a mode switching instruction to the processor elements PE₀ to PEₙ and power supply control chip 4 even at the same time.

In the first embodiment, execution time information on the Sleep mode (e.g., a time parameter indicating how many seconds passes before the normal mode is restored) is added to the mode switching instruction to change to the Sleep mode.

When having processed the specified job, the processor elements PE₀ to PEₙ go into the mode specified by the control multiprocessor element CPE.

For example, when, according to a mode switching instruction to make the transition to the Sleep mode, the power control chip 4 stops the power supply by any one of the power supply modules, the processor element corresponding to the power supply module goes into the Sleep mode. When the execution time of the Sleep mode has elapsed for the processor element in the Sleep mode, the power supply control chip 4 starts to supply power to the processor element in the Sleep mode, with the result that the processor element automatically returns to the normal mode.

Instead of adding information on the execution time of the Sleep mode to the Sleep mode switching instruction, the mode control unit 7 may transmit a Sleep mode switching instruction to stop the power supply and, after the execution time of the Sleep mode, transmit a Sleep mode switching instruction to start to supply power.

When directly receiving a mode switching instruction to make the transition to the Rest mode from the control multiprocessor element CPE, the processor elements PE₀ to PEₙ go into the Rest mode according to the mode switching instruction. For example, when receiving a mode switching instruction indicating the Rest mode, the processor elements PE₀ to PEₙ close their clock gates G₀ to Gₙ and go into the Rest mode. Moreover, for example, when receiving a mode switching instruction indicating the transition to the normal mode, the processor elements PE₀ to PEₙ open their clock gates G₀ to Gₙ and go into the normal mode.

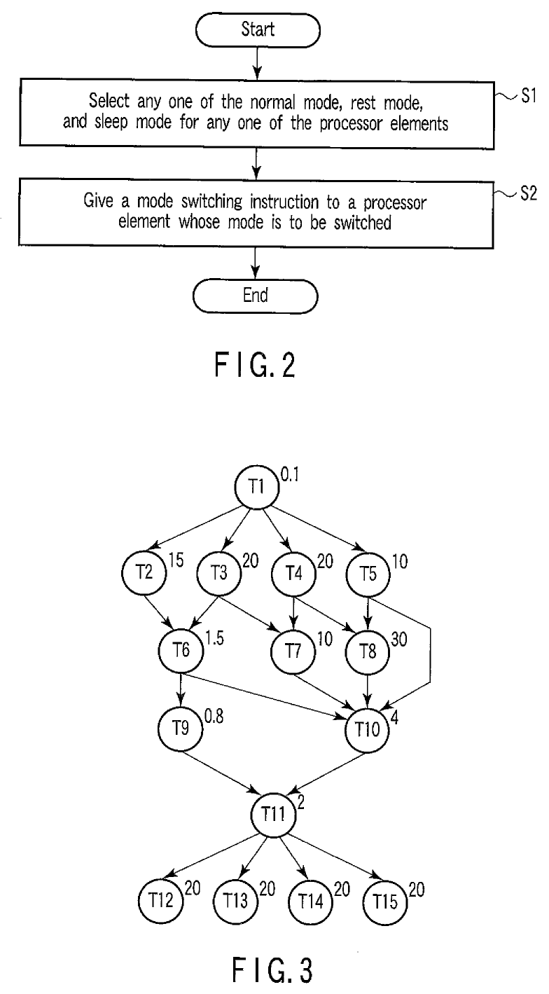

FIG. 2 is a flowchart showing an example of an operation of the control processor element CPE according to the first embodiment.

In step S1, the selection unit 6 of the control processor element 1 selects any one of the normal mode, Rest mode, and Sleep mode for the processor element whose mode is to be switched among the processor elements PE₀ to PEₙ on the basis of the job input schedule.

In step S2, to execute the operation corresponding to the mode selected by the selection unit 6, the mode control unit 7 of the control processor element 1 issues a mode switching instruction to the processor element whose mode is to be switched.

FIG. 3 is a task flow graph showing an example of the application program 3a to be executed by the multiprocessor 1 according to the first embodiment.

The task flow graph is created at the time of the compilation of the application program 3a. In FIG. 3, a circle indicates a task and the numeral in the circle indicates a task number. The number at the top right of the circle indicates an anticipated execution time of the task (e.g. seq). The anticipated execution time is obtained by static analysis by the compiler.

As <First Example>, the selection of the Rest mode for the task flow of FIG. 3 will be explained.

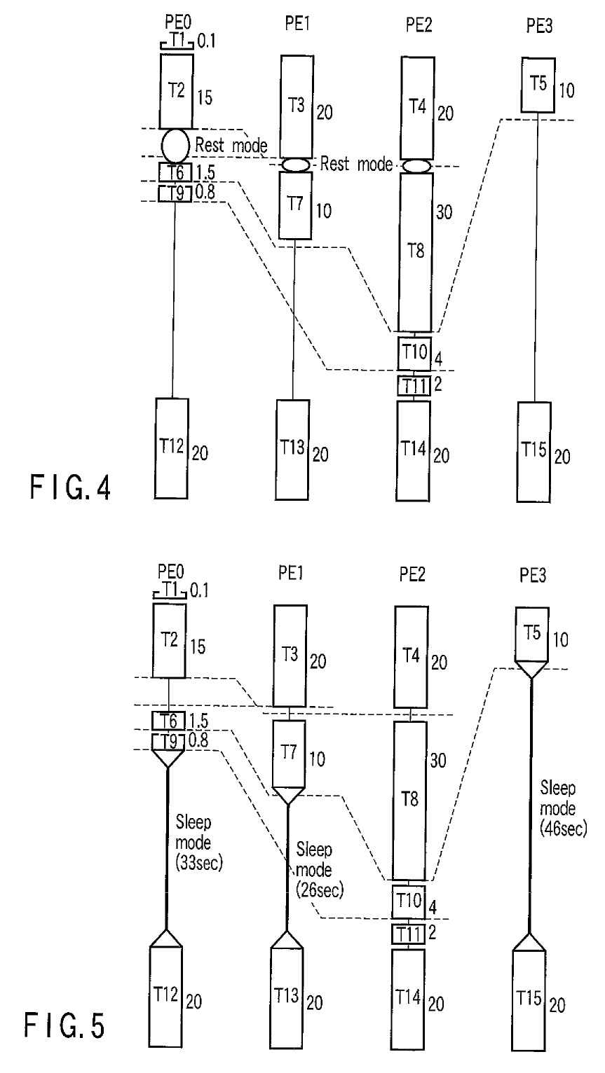

FIG. 4 shows an example of electric power consumption suppression at the time of barrier synchronization in the Rest mode.

Task T6 requires the execution results of tasks T2 and T3 and task T7 requires the execution results of tasks T3 and T4.

As described above, when there are subsequent tasks depending on a plurality of task execution results, barrier synchronization is needed between preceding tasks (e.g., tasks T2 and T3).

When tasks whose anticipated execution times are nearly equal to the extent that barrier synchronization is needed like tasks T2, T3 or tasks T3, T4 are input, it is expected that both of the tasks end as simultaneously as possible and are processed with neither time nor power loss.

Actually, however, there is a shift in the ending time of the tasks because of the problem of the microarchitecture dependence of the processor elements and the problem of the memory architecture, etc.

Therefore, in a case where barrier synchronization is needed and tasks whose anticipated execution times are almost equal are input, the control processor element CPE informs the processor element to be controlled in advance of a mode switching instruction to show the Rest mode so that the processor element may go into the Rest mode after the completion of the task.

Immediately after having completed the execution of the task, the processor element to be controlled goes into the Rest mode.

As a result, even if there is a difference in the ending time between the tasks which require barrier synchronization, wasteful electric power consumption can be suppressed.

When a new task is input to the processor elements in the Rest mode, the control processor element informs the processor element whose mode is to be switched of a mode switching instruction to return to the normal mode. In this case, since the return time from the Rest mode to the normal mode is short, a task can be input with almost no loss.

As <Second Example>, the selection of the Sleep mode for the task flow of FIG. 3 will be explained.

FIG. 5 shows an example of electric power consumption suppression at the time of barrier synchronization in the Sleep mode.

Task T5 is a precedent-dependent task followed by task T10 like task T6 to task T8.

If <First Example> explained above is followed, task T5 is a task to go into the Rest mode immediately after the completion of the task execution.

However, it is recognized that there is no subsequent task to be allocated for a while (exceeding a certain threshold value) in the processor element PE₃ on which task T5 has been mapped by static scheduling after the completion of the execution of task T5.

In this case, the control processor element CPE informs the power supply control chip 4 for 46 seconds after the completion of the execution of task T5 on the processor element PE₃ of a mode switching instruction to go into the Sleep mode.

Each of the mode switching time from the normal mode to the Sleep mode and the mode switching time from the Sleep mode to the normal mode is longer than that of the Rest mode. That is, since the mode changes from the Sleep mode to the normal mode at the time that the processor element PE₃ is needed for the processing of a task, time loss becomes great. Therefore, in <Second Example>, the execution time of the Sleep mode is so determined that the mode switching time from the normal mode to the Sleep mode, the execution time of the Sleep mode, and the mode switching time from the Sleep mode to the normal mode are included in the time from when the execution of task 5 is completed until the next task T15 is started.

In the first embodiment explained above, one of the normal mode and the electric power consumption suppressing modes in two stages is selected according to the characteristic of the input task. This enables the multiprocessor 1 which executes the application program 3a to operate with suitable electric power consumption.

In the first embodiment, the execution time of the Sleep mode is determined, taking the mode switching time into account. This makes it possible to suppress the electric power consumption without affecting the task execution schedule.

In the first embodiment, tasks which need not be executed in parallel are concentrated into one processor as much as possible and are executed. By doing this, the number of times the mode is switched can be decreased, which produces a greater electric power consumption suppressing effect.

In the first embodiment, the arrangement of the individual component elements may be changed, combined suitably, or divided freely, or some of the component elements may be deleted, provided that each of the component elements can realize a corresponding operation. That is, the first embodiment is not restricted to the above configuration and may be embodied by modifying the component elements without departing from the spirit or essential character of the invention.

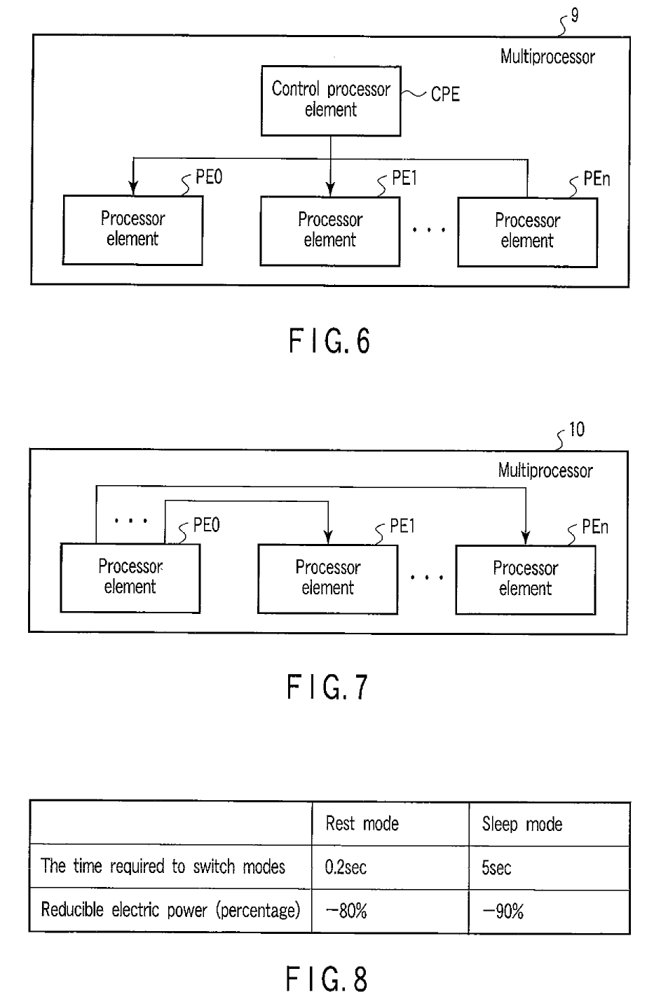

For example, the power supply control chip 4 and power supply modules E₀ to Eₙ may be eliminated and each of the processor elements PE₀ to PEₙ may have the function of turning on or off the power supply according to a mode switching instruction. That is, as a multiprocessor 9 illustrated in FIG. 6, each of the processor elements PE₀ to PEₙ may have the function of receiving a mode switching instruction and switching the mode thereof according to the received mode switching instruction.

Moreover, for example, a single power supply module may be caused to correspond to a plurality of processor elements PE₀ to PEₙ and the power supply module may provide ON/OFF control of the supply of electric power to each of the processor elements PE₀ to PEₙ.

Furthermore, for example, a device which is a combination of the power supply modules E₀ to Eₙ and power supply control chip 4 may supply power to any one of the processor elements PE₀ to PEₙ and stop the supply of power to other processor elements.

For example, as shown in FIG. 7, any one of the processor elements PE₀ to PEₙ may carry out the same operation as that of the control processor element CPE of the first embodiment. In the multiprocessor 10 of FIG. 7, the processor element PE₀ manages the job input schedule and informs the other processor elements PE₁ to PEₙ of a mode switching instruction. The processor elements PE₁ to PEₙ switch the mode according to the mode switching instruction. The processor element PE₀ may be used in executing the application program 3a.

### Second Embodiment

In a second embodiment of the invention, a modification of the first embodiment will be explained. In the second embodiment, an explanation will be given about a comparison between a case where optimization is performed to concentrate tasks which need not be executed in parallel into a specific processor element and a case where they are not concentrated.

In the second embodiment, it is assumed that, of 100% of the power consumed in the multiprocessor, 50% is consumed in AC, 40% is consumed in the clock, and 10% is consumed in DC. Here, AC means the power consumed in the operation of a circuit. The clock means the power consumed in the clock supplied to the block. DC means the leakage power of the circuit.

Moreover, in the second embodiment, suppose the Rest mode is a mode in which the operating frequency is suppressed to ¼ and the Sleep mode is a mode in which the supply of the clock is stopped (clock gating).

In this case, as illustrated in FIG. 8, in the Rest mode, it is possible to suppress the following power: 50% AC+40% clock×(¾)=80% power. In the Rest mode, the mode switching time is assumed to be 0.2 sec.

On the other hand, in the Sleep mode, 50% of the AC power consumption and 40% of the clock power consumption are cut, which makes it possible to suppress 90% of the power. Moreover, in the Sleep mode, the mode switching time is assumed to be 5 sec.

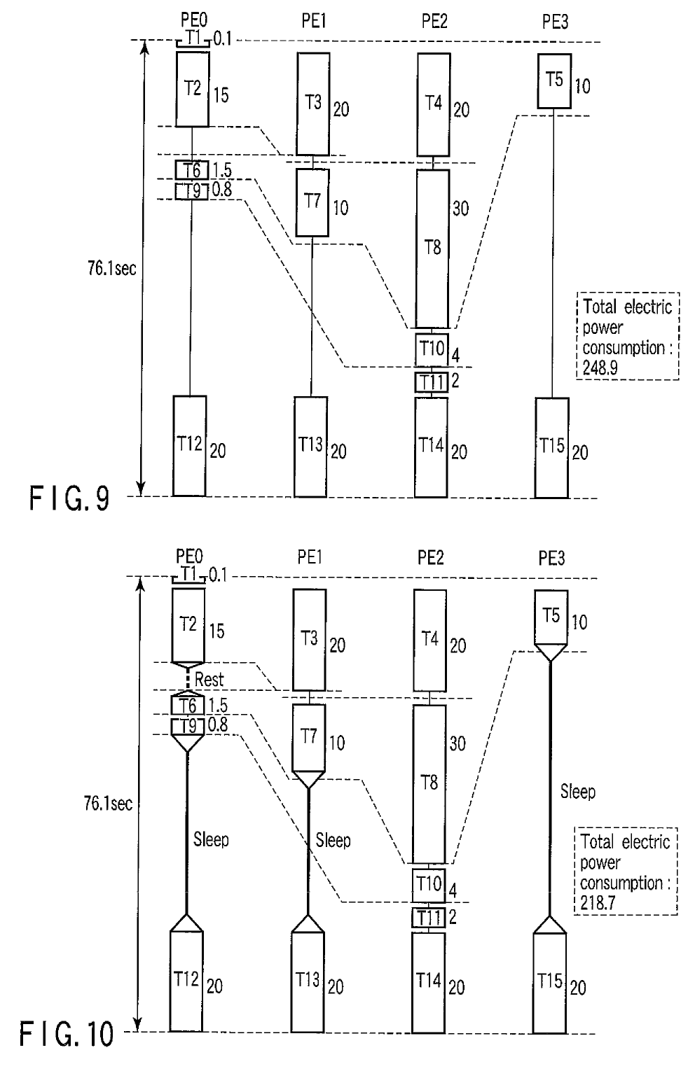

FIG. 9 shows a task flow graph in a case where as many tasks as possible are concentrated into the processor element PE₂ and the processor elements PE₀ to PE₃ are in the idle state (with no mode switching) between tasks.

The evaluated value for the total electric power consumption for the task flow graph of FIG. 9 is 248.9.

FIG. 10 shows a task flow graph in a case where optimization is performed to concentrate tasks which need not be executed in parallel into a specific processor element PE₂ and mode switching is done.

The evaluated value for the total electric power consumption for the task flow graph of FIG. 10 is 218.7.

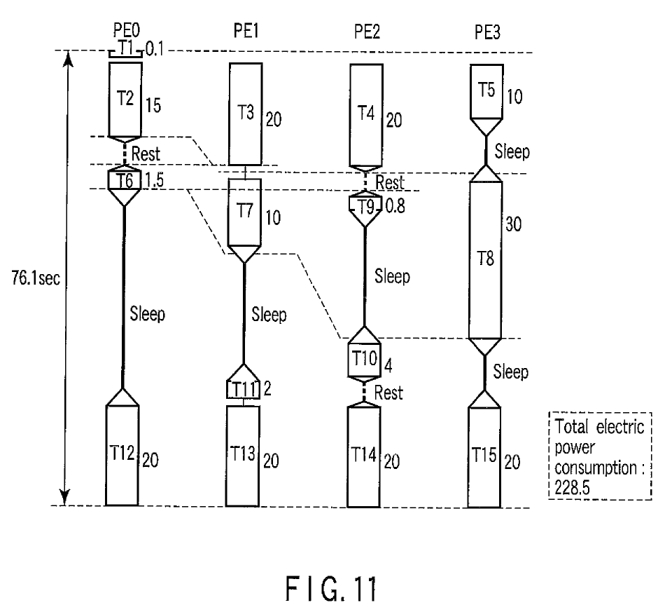

FIG. 11 shows a task flow graph in a case where the task arrangement hasn't been optimized and mode switching is done.

The evaluated value for the total electric power consumption for the task flow graph of FIG. 11 is 228.5.

The evaluated values obtained in a simulation on the task flow graphs of FIGS. 9 to 11 show a state where the smaller the number, the more the electric power consumption is suppressed.

From the simulation, it is confirmed that switching to the Rest mode and Sleep mode enables the electric power consumption to be suppressed more than no mode switching and that optimization enables the electric power consumption to be suppressed further.

In each of the above embodiments, frequency suppression may be applied to the Rest mode and power stoppage be applied to the Sleep mode.

### Third Embodiment

In a third embodiment of the invention, a control unit for a microprocessor obtained by modifying the first and second embodiments and further dividing the Rest mode into a plurality of modes will be explained.

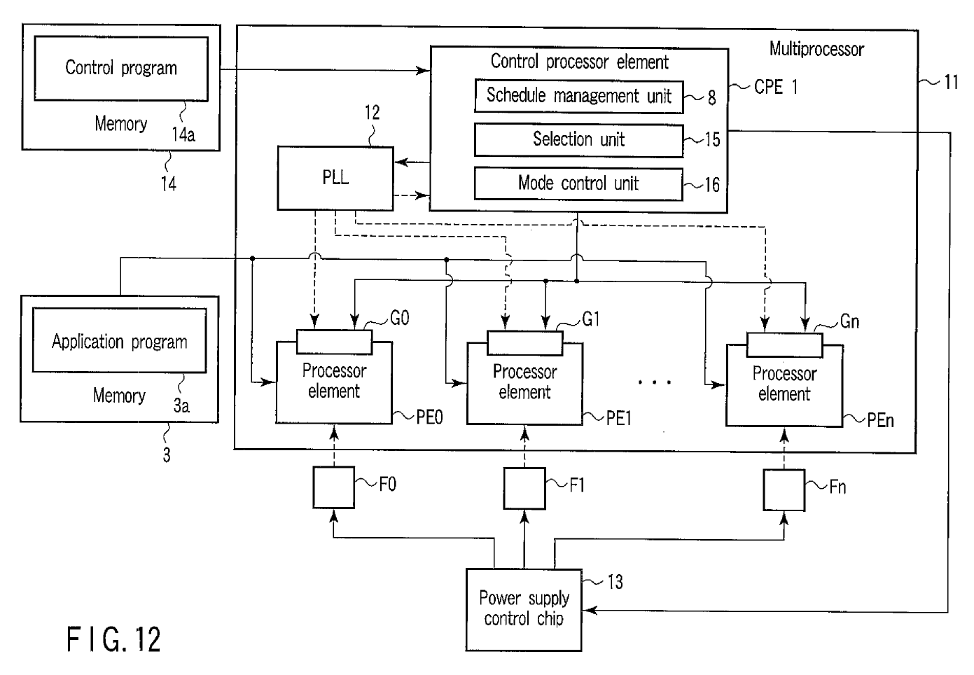

FIG. 12 is a block diagram showing an example of a multiprocessor which includes a control processor element of a third embodiment.

A multiprocessor 11 includes a plurality of processor elements PE₀ to PEₙ r a PLL (Phase Locked Loop) 12, and a control processor element CPE1.

The processor elements PE₀ to PEₙ execute an application program 3a stored in a memory 3.

Power supply modules F₀ to Fₙ supply power to the processor elements PE₀ to PEₙ, respectively.

According to a power supply switching instruction given from the control processor element CPE1, a power supply control chip 13 switches between power supply and power stoppage by the power supply modules F₀ to Fₙ. Moreover, the power supply control chip 13 varies the power supply voltage supplied to each of the power supply modules F₀ to Fₙ.

In the third embodiment, the explanation will be given using a case where the power supply modules F₀ to Fₙ are caused to correspond to the processor elements PE₀ to PEₙ, respectively.

The control processor element CPE1 executes a control program 14a stored in a memory 14 and functions as a schedule management unit 8, a selection unit 15, and a mode control unit 16.

On the basis of an execution schedule for a plurality of tasks included in the application program 3a allocated to the processor elements PE₀ to PEₙ, respectively, the selection unit 15 selects any one of the normal mode, a plurality of stages of Rest modes R1 to R3, and Sleep mode for each of the processor elements PE₀ to PEₙ.

While in the third embodiment, the Rest mode is divided into three stages, the number of stages may be changed freely according to, for example, the relationship between the electric power consumption and the time between tasks.

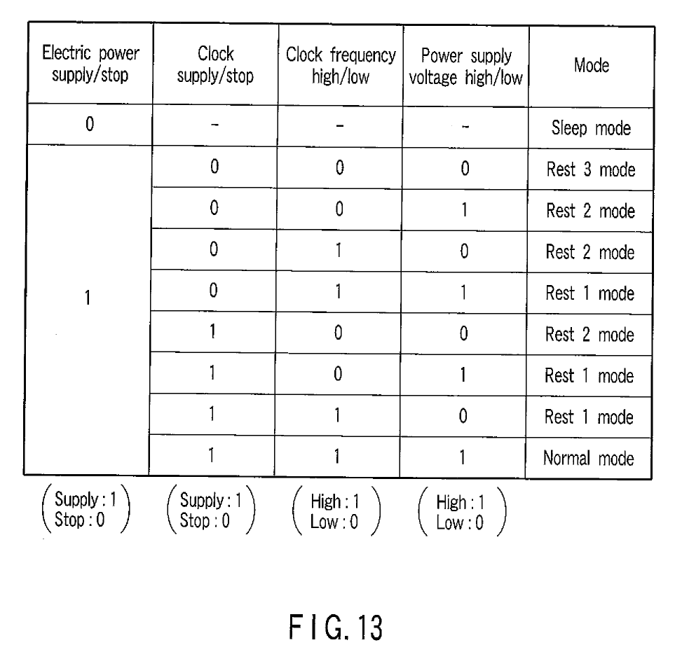

FIG. 13 is a table showing an example of the relationship between various modes, power supply/stop, clock supply/stop, clock frequency, and power supply voltage.

In the item “Power supply/stop,” a power supply state is represented as 1 and a power supply stop state as 0.

In the item “Clock supply/stop,” a clock supply state is represented as 1 and a clock supply stop state as 0.

In the item “Clock frequency high/low,” a clock frequency high state is represented as 1 and a clock frequency low state as 0.

In the item “Power supply voltage high/low,” a power supply voltage high state is represented as 1 and a clock frequency low state as 0.

When all of the items “Power supply/stop,” “Clock supply/stop,” “Clock frequency high/low,” and “Power supply voltage high/low” are at 1, this means the normal mode.

Of the four item values, when two item values are 1, this is set as Rest mode R1, when one item value is 1 (or when two item values are 0), this is set as Rest mode R2, and when no item value is 1 (or when three item values are 0), this is set as Rest mode R3.

The electric power consumption decreases in the order of Rest modes R1, R2, and R3.

Suppose the time between tasks to which Rest modes R1, R2, R3 are allocated increases in the order of Rest modes R1, R2, and R3.

When the item value of “Power supply/stop” is 0, this means the Sleep mode.

The selection unit 15 selects any one of Rest modes R1 to R3 according to the time from when the execution of a task is completed until the execution of the next task is started for each of the processor elements PE₀ to PEₙ. The time between tasks to which Rest modes R1 to R3 area allocated has been set independently.

A method of selecting either the normal mode or the Sleep mode is the same as that in the first and second embodiments.

The mode control unit 16 performs control of each of the processor elements PE₀ to PEₙ according to the mode selected by the selection unit 15.

Specifically, on the basis of the result of selecting any one of the normal mode, Rest modes R1 to R3, and Sleep mode, the mode control unit 16 makes the switch to at least one of the items “Power supply/stop,” “Clock supply/stop,” “Clock frequency high/low,” and “Power supply voltage high/low” for any one of the processor elements PE₀ to PEₙ.

For example, to switch between the high and low of the clock frequency, the mode control unit 16 informs the PLL 12 of identification data on the processor element whose clock frequency is to be switched and a frequency switching instruction.

For example, to switch between the high and low of the power supply voltage, the mode control unit 16 informs the power supply control chip 13 of identification data on the processor element whose power supply voltage is to be switched and a power supply voltage switching instruction.

To switch between power supply and power supply stop and between clock supply and clock supply stop, the mode control unit 16 operates in the same manner as in the first and second embodiments.

The PLL 12 supplies the clock to each of the processor elements PE₀ to PEₙ. Moreover, the PLL 12 receives a frequency switching instruction and identification data on the processor element whose frequency is to be switched. Then, according to the frequency switching instruction, the PLL 12 changes the frequency of the clock supplied to the processor element specified in the identification data.

According to a power supply/stop switching instruction from the control processor element CPE1, the power supply control chip 13 switches between the power supply and the power supply stop of the power supply modules F₀ to Fₙ in the same manner as the power supply control chip 4 of the first embodiment.

Furthermore, the power supply control chip 13 receives a power supply switching instruction and identification data on the processor element whose power supply voltage is to be switched from the control processor element CPE1. Then, according to the power supply voltage switching instruction, the power supply control chip 13 changes the power supply voltage of the power supply module corresponding to the processor element specified in the identification data.

Under the control of the power supply control chip 13, the power supply modules F₀ to Fₙ switch between the supply and the supply stop of power to the processor elements PE₀ to PEₙ, respectively, and switch the power supply voltages.

In the third embodiment, the Sleep mode and Rest mode are used to suppress the electric power consumption. Moreover, since the Rest mode is further divided into a plurality of stages, the electric power consumption can be suppressed suitably according to the task scheduling.

While in the third embodiment, the Rest mode has been divided into a plurality of stage, the Sleep mode may be divided into a plurality of stages in the same manner.

### Fourth Embodiment

In a fourth embodiment of the invention, an explanation will be given about an accelerator which includes a plurality of computing units (or processor elements) that can be connected to an information processing unit and execute a program by parallel processing and a unit which performs suppressing control of the power consumption of the information processing unit connected to the accelerator.

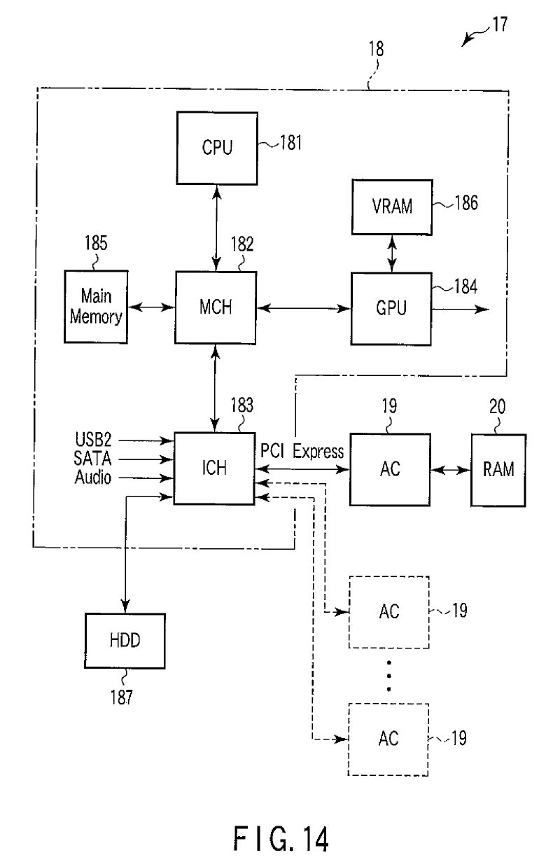

First, based on FIG. 14, a configuration of an information processing device according to a fourth embodiment of the present invention will be described. FIG. 14 is a configuration diagram showing the configuration of the information processing device according to the present embodiment.

An information processing device 17 is configured to include a PC 18 which is a computer having a PC architecture. An accelerator 19 is attachable to, that is, connectable to the PC 18. The PC 18 is an information processing device configured to include a CPU (Central Processing Unit) 181, an MCH (Memory Controller Hub) 182, an ICH (I/O Controller Hub) 183, a GPU (Graphics Processing Unit) 184, a main memory 185 and a VRAM (Video RAM) 186 as an image memory. Thus, the information processing device 17 is configured in which the accelerator 19 is connected to the PC 18 having such a PC architecture. It should be noted that although an example of the PC architecture including of the CPU 181, the MCH 182, the ICH 183 and the GPU 184 is shown as the PC architecture in the present embodiment, the PC architecture is not limited to such a configuration.

Particularly, the MCH 182 is a semiconductor device chip having so-called Northbridge functionality including functions of connection between the CPU 181 and the main memory 185 and the like. The ICH 183 is a semiconductor device chip having so-called Southbridge functionality, such as connecting to another component such as a hard disk device (hereinafter referred to as “HDD”) 187 via a PCI bus, a USB or the like, and here, the ICH 183 controls input/output of each signal depending on standards such as USB2, SATA (Serial ATA), Audio and PCI Express. Moreover, the GPU 184, which is a processing unit for graphics, is a so-called graphic engine and is a semiconductor device chip configured to perform a calculation process required for displaying three-dimensional graphics.

The accelerator (hereinafter abbreviated as “AC”) 19 as an additional device having a calculation function is a chip which is connected to the ICH 183 and further also connected to a RAM (may be a flash memory or the like) 20 as its own working memory. A configuration of the AC 19 as a peripheral device will be described later. It should be noted that the RAM 20 may be provided within the AC 19.

The CPU 181 can execute various application programs, including high load programs and low load programs. Therefore, the CPU 181 can request and cause the AC 19 to execute high load application programs, for example, an image recognition application program, an application program for video replay and the like. Specifically, if the AC 19 is used to execute an application program in the information processing device 1, the CPU 181 outputs a predetermined command with respect to the AC 19, and the AC 19 receives the command and performs a process of the program specified by the CPU 181. In that case, for example, if the AC 19 performs the specified process, for example, an image recognition process, the AC 19 reads a stream signal from the SATA or the like via DMA, performs the recognition process, transfers result data of the recognition process to the CPU 181 or GPU 184 and the like via the DMA, and outputs the result data.

The PCI Express has one or more lanes. The ICH 183 and the AC 19 are connected via the PCI Express having a predetermined number of lanes, for example, 1, 2, 4 or 8 lanes or the like. The number of the lanes is set by BIOS or the like. For example, the ICH 183 and the AC 19 are connected via a 4-lane PCI Express.

It should be noted that, as shown by dotted lines in FIG. 14, multiple ACs 19 may be connected to the ICH 183 so that each of the multiple ACs 19 is connected to each lane of the PCI Express. Consequently, an application program with a high calculation processing load can be accommodated by increasing the number of processing units as described below.

Furthermore, it should be noted that when the multiple ACs 19 are connected to the ICH 183, each AC 19 and the ICH 183 may be connected via multiple lanes.

The AC 19 is a processor of a semiconductor device, which has multicore/multiprocessor architectures capable of parallel processing, and controls an operation and a processing capability of each calculation unit.

In the present embodiment, the AC 19 includes multiple calculation units capable of processing the program in parallel, and when the AC 19 executes the specified process, the AC 19 itself determines sharing of the process among the multiple calculation units and causes the respective calculation units to execute the process. In the determination of the sharing, the AC 19 itself determines which calculation unit among the multiple calculation units is caused to execute the process, supplies power to the calculation unit which executes the process, and also determines and sets an operating frequency in the execution thereof.

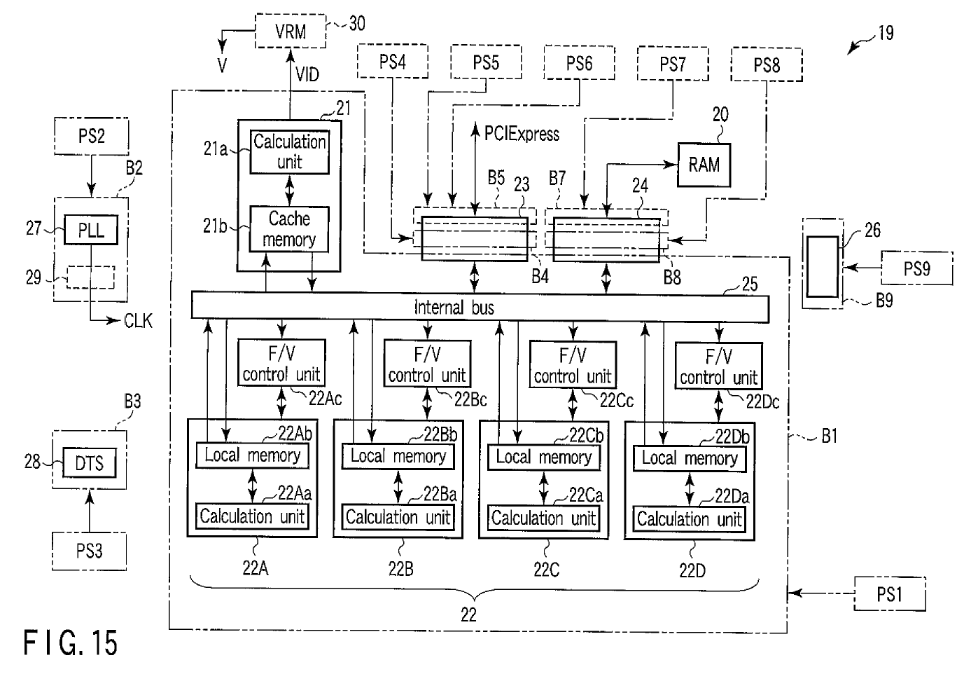

Next, the configuration of the AC 19 will be described. FIG. 15 is a block diagram illustrating the configuration of the AC 19. The AC 19 includes a control processing unit (hereinafter abbreviated as “CPE”) 21, multiple, here four processing units (hereinafter abbreviated as “PEs”), and an interface unit (hereinafter abbreviated as “I/F section”) 23. The four PEs are assumed as a PE 22A, a PE 22B, a PE 22C and a PE 22D, respectively. Hereinafter, the four PEs will be collectively referred to as “PE 22”, or one PE will be referred to as “PE 22”. Furthermore, the AC 19 includes an I/F unit 24 and can read the program and data in the RAM 20 connected to the AC 19. The CPE 21, each PE 22, the I/F unit 23 and the I/F unit 24 are connected to one another via an internal bus 25. The I/F unit 23 is a circuit configured to interface the internal bus 25 with a PC architecture bus. When the CPE 21 is powered on, the program and the data are loaded from the CPU 181 and stored in the RAM 20. It should be noted that a ROM may be provided in the AC 19, the program and the data may have been stored in the ROM, and the CPE 21 may read the program and the data from the ROM. Furthermore, other input/output terminals 26, a PLL circuit 27 and a digital temperature sensor (hereinafter abbreviated as “DTS”) 28 are also provided in the chip of the AC 19.

The CPE 21 internally includes a calculation unit 21a which is a control unit, and a cache memory 21b. Each PE includes the calculation unit and a local memory. Moreover, each PE is provided with a frequency/voltage control (hereinafter abbreviated as “F/V control”) unit. Specifically, the PEs 22A, 22B, 22C and 22D (hereinafter collectively referred to as “PE 22”, or one PE will be referred to as “PE 22”) have calculation units 22Aa, 22Ba, 22Ca and 22Da (hereinafter collectively referred to as “calculation unit 22a”, or one calculation unit will be referred to as “calculation unit 22a”) and local memories 22Ab, 22Bb, 22Cb and 22Db (hereinafter collectively referred to as “local memory 22b”, or one local memory will be referred to as “local memory 22b”), respectively. Also, the respective PEs 22 are provided with F/V control units 22Ac, 22Bc, 22Cc and 22Dc (hereinafter collectively referred to as “F/V control unit 22c”, or one F/V control unit will be referred to as “F/V control unit 22c”).

The calculation unit 22a is a circuit configured to process a processing program in parallel based on a request from the CPE 21. Although the calculation unit 22a may be an application specific hardware engine, the calculation unit 22a is a programmable general purpose processing unit in the present embodiment. Each calculation unit 22a is a resource for an internal calculation in the AC 19. As will be described later, the calculation unit 22a processes the processing program in parallel by using one or more calculation units.

Here, the calculation unit 22a is a calculation unit which can perform a SIMD calculation with respect to data of 128 bit data width. Furthermore, the calculation unit 22a can perform 32-bit single precision and 64-bit double precision floating calculations.

Each local memory 22b is a storage unit configured to store the processing program and target data which is data to be processed. Each local memory 22b has a memory capacity of 256 KB

For example, in each PE 22, if the image recognition process with respect to image data, or codec processes such as encoding and decoding processes with respect to the image data are performed, the data to be processed which has been read from the HDD 187 or a camera (not shown) is stored in each local memory 22b, in a state of having been divided depending on a capacity of each local memory 22b. Then, each calculation unit 22a executes a predetermined process with respect to the stored data with the SIMD calculation, and stores a result of the execution in each local memory 22b. In each PE 22, after the predetermined process has been completed, the processed data is transferred from the local memory 22b to the HDD 187, data to be processed next is transferred from the HDD 187 to each local memory 22b, and the predetermined process is performed as described above. By repeating the above described process, in the information processing device 17, the AC 19 is used to smoothly perform the image recognition process and the like.

Each F/V control unit 22c is an operation control unit configured to control both the operation and the processing capability of the corresponding calculation unit 22a, and specifically, is a circuit having a function configured to change a frequency of a clock signal supplied to the corresponding calculation unit 22a, a function configured to supply and stop the clock signal supplied to each circuit in the calculation unit 22a, and a function configured to supply and stop the power supplied to each circuit in the calculation unit 22a. It should be noted that a clock CLK supplied to each circuit is supplied from the PLL circuit 27.

It should be noted that, although here the F/V control unit 22c is provided for each PE 22, one F/V control unit 22c may be provided with respect to the whole of the four PEs 22 and the change of the frequency of the clock signal, the supply and the stop of the clock signal, and the supply and the stop of the power may be performed with respect to the whole of the four PEs 22. In that case, an output of the PLL circuit 27 is outputted via a switching circuit 29 shown by a dotted line in FIG. 15, and a control signal configured to stop the supply of the clock is supplied with respect to the switching circuit 29 from the CPE 21.

As will be described later, a function configured to change the operating frequency is a function configured to reduce the operating frequency of each calculation unit 22a in each PE 22 and optimize power consumption due to the clock signal, if a calculation performance which can be provided by each calculation unit 22a in each PE 22 is high in comparison with a load of the processing program.

The function configured to supply and stop the clock signal, that is, a clock gating function is a function configured to supply and stop the clock signal with respect to each calculation unit 22a in each PE 22 and the like. When the supply of the clock signal is stopped, the power consumption due to the clock signal can be reduced to 0 (zero).

The function configured to supply and stop the power is a function configured to supply and stop the power with respect to each calculation unit 22a in each PE 22 and the like. When the supply of the power is stopped, the power consumption due to a leak current in an internal circuit can be reduced to 0 (zero).

The clock frequency supplied to each calculation unit 22a shows the processing capability of each calculation unit 22a. When the operating frequency is a maximum operating frequency which has been previously determined with respect to each calculation unit 22a, the processing capability of the calculation unit 22a is maximized, and each F/V control unit 22c can control the processing capability of the calculation unit 22a to be less than or equal to its maximum processing capability by changing the operating frequency to be less than or equal to its maximum operating frequency.

Moreover, each F/V control unit 22c can stop the operation of each calculation unit 22a by stopping the supply of the clock signal to be supplied to each calculation unit 22a. Similarly, each F/V control unit 22c can stop the operation of the calculation unit 22a by stopping the supply of the power to be supplied to each calculation unit 22a, for example, a supply voltage. Therefore, each F/V control unit 22c can control the operation of each calculation unit 22a by changing the frequency of the clock signal to the calculation unit 22a, controlling the supply of the clock signal, that is, performing clock gating, or controlling the supply of the power to each calculation unit 22a.

It should be noted that although each F/V control unit 22c controls both the operation and the processing capability of the corresponding calculation unit 22a in the present embodiment, each F/V control unit 22c may control at least one of the operation and the processing capability.

As will be described later, the calculation unit 21a of the CPE 21 controls each PE 22 and each F/V control unit 22c. Thus, the control of the operation and the processing capability of the calculation unit 22a by each F/V control unit 22c is performed in response to an instruction from the calculation unit 21a of the CPE 21.

As described above, when the calculation unit 21a which is the control unit receives the command of executing the predetermined process from the CPU 181, the calculation unit 21a outputs a predetermined instruction with respect to the four PEs 22. The predetermined instruction includes an instruction on which PE 22 executes the process, an instruction on which operating frequency is provided at that time, and the like.

Moreover, the CPE 21 of the AC 19 outputs a predetermined code signal VID, for example, a 6-bit signal, with respect to a VRM (Voltage Regulator Module) 30 which is a variable power supply and an external power supply circuit module, and the VRM 30 supplies a power supply voltage V depending on the predetermined code signal VID to the AC 19.

Furthermore, the respective circuits on the AC 19 are divided into multiple blocks, which are 13 blocks here, and the AC 19 is configured so that the power is separately supplied for each divided block. In other words, with respect to each power supply, a block of circuit parts to which its power is supplied has been previously determined, and each power supply supplies the power only to the corresponding block which has been previously determined. Specifically, a block B1 including the CPE 21 is supplied with the power from a power supply PS1 for internal logics. A block B2 including the PLL circuit 27 is supplied with the power from an analog power supply PS2 for a PLL unit. A block B3 including the DTS 28 is supplied with the power from an analog power supply PS3 for a digital temperature sensor unit. A block B4 including a part of the I/F 23 for the PCI Express is supplied with the power from a power supply PS4 for a first PCI Express logic. A block B5 including other parts of the I/F 23 for the PCI Express is supplied with the power from a power supply PS5 for a second PCI Express logic and the power from an analog power supply PS6 for the PCI Express. A block B7 including a part of the I/F 24 is supplied with the power from an analog power supply PS7 for the I/F 24. A block B8 including other parts of the I/F 24 is supplied with the power from a power supply PS8 for an I/F 24 logic. A block B9 including the other input/output terminals 26 is supplied with the power from a power supply PS9 for the other input/output terminals 26. The respective four PEs 22 are supplied with the power from power supplies for the PE, PS10, PS11, PS12 and PS13, respectively.

For example, in a state where the application program is executed and the AC 19 is used, the CPU 181 controls the power supply from the respective power supplies so that the respective circuit units are supplied with the power from all of the power supplies PS1 to PS13. Moreover, for example, in a state where the AC 19 is not used, the CPU 181 controls the power supply so that unnecessary power is not supplied. More specifically, when the CPU 181 instructs a device state with respect to the AC 19, the CPE 21 receives information on the device state, and depending on the information, instructs power supply states of the respective power supplies PS1 to PS13 with respect to an external power supply controller 31. According to the instruction on the power supply states, the external power supply controller 31 changes the power supply states of the respective power supplies PS1 to PS13. The device state includes states such as a full state D0 of supplying the power from all of the power supplies PS1 to PS13 as described above, a state D1 of performing the power supply only from some power supplies among the power supplies PS1 to PS13, and a so-called sleep state D2.

As described above, depending on the state of the information processing device 17, here, depending on a usage state of the AC 19, the CPU 181 controls the power supply with respect to each block in the AC 19.

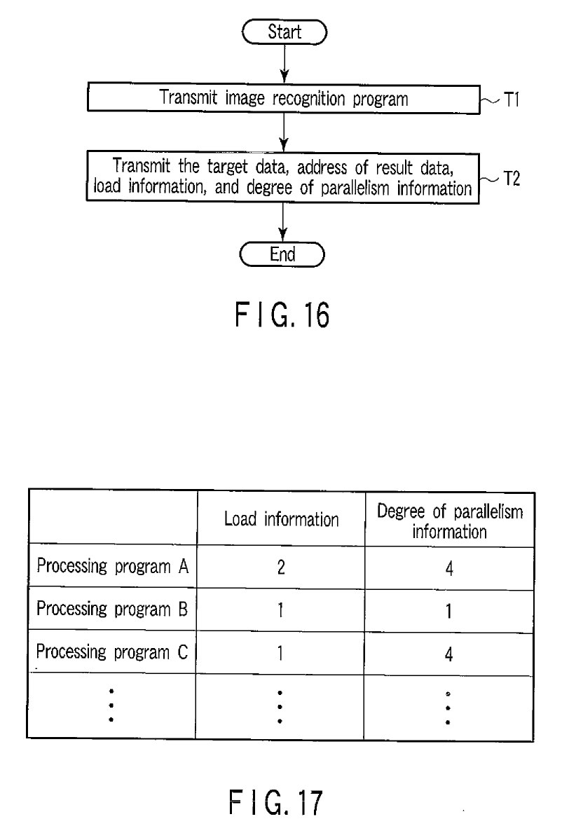

FIG. 16 is a flowchart showing an example of a flow of the process in the CPU 181. A processing program in the CPU 181 is stored in the main memory 185, and executed by the CPU 181.

An example of a case of causing the AC 19 to share one process, which is the image recognition process here, in the middle of executing various processes by the CPU 181 will be described. After the CPU 181 has executed a predetermined preprocess before requesting the process with respect to the AC 19, the CPU 181 transmits the image recognition program to the AC 19 (step T1). The calculation unit 21a of the CPE 21 stores the image recognition program from the CPU 181 in the RAM 20.

Next, the CPU 181 transmits an address of target data which is a target of the image recognition process, an address of result data of the recognition process, load information on the image recognition program, and degree of parallelism information on the image recognition program to the AC 19 (step T2). The AC 19 accumulates the received load information and the received degree of parallelism information in the RAM 20.

The load information is information showing weight of the process, and the degree of parallelism information is information showing a degree of capability to process the processing program in parallel. In the present embodiment, an example of showing the load information and the degree of parallelism information in integers 0, 1, 2, . . . including 0 (zero) will be described. The load information shows that the larger its number is, the larger the load of the process is. The degree of parallelism information shows that the process is a process which can be executed by the number of PEs depending on its number.

The load information and the degree of parallelism information have been previously determined for each processing program and stored in the main memory 185. FIG. 17 is a diagram showing an example of table data showing the load information and the degree of parallelism information.

As shown in FIG. 17, the load information and the degree of parallelism information have been previously set for each processing program. A processing program A is shown to have the load of 2 and the degree of parallelism of 4. A processing program B is shown to have the load of 1 and the degree of parallelism of 1. A processing program C is shown to have the load of 1 and the degree of parallelism of 4.

Since the table data of FIG. 17 has been previously stored in the main memory 185, the CPU 181 can read and obtain the load information and the degree of parallelism information on the processing program which is requested with respect to the AC 19, from the main memory 185, and transmit the load information and the degree of parallelism information to the AC 19.

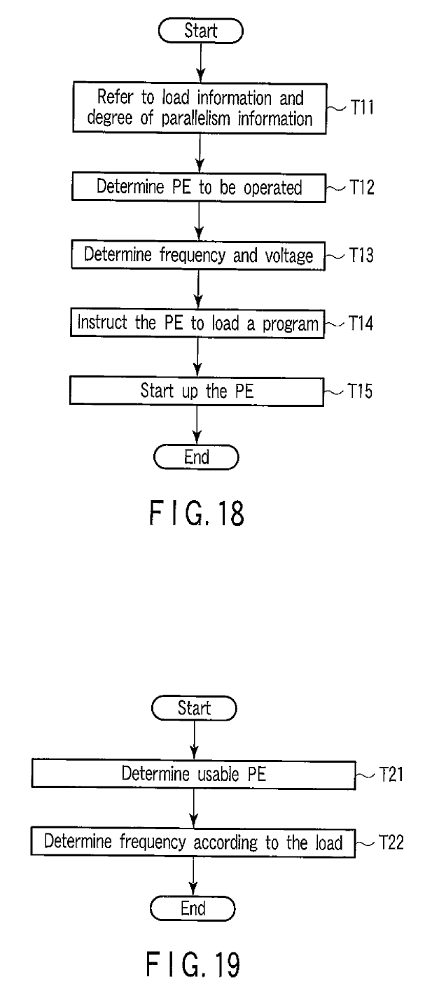

Next, a process in the calculation unit 21a of the CPE 21 in the AC 19 will be described. FIG. 18 is a flowchart showing an example of the process in the CPE 21.

When the above described process is requested from the CPU 181, the CPE 21 refers to the received load information and the received degree of parallelism information, and stores the load information and the degree of parallelism information in the RAM 20 (step T11).

The CPE 21 determines the PE to be operated, based on the load information and the degree of parallelism information (step T12). In other words, the CPE 21 couples the load information with the degree of parallelism information to determine one or more PEs 22 to be operated, and the number of operating PEs 22 is determined. In the present embodiment, the degree of parallelism shows a maximum number of the calculation units which can perform the parallel process, and assuming that an amount of process which can be executed by one PE 22 is 1, the load shows a ratio with respect to the amount of process. Thus, based on the received load information and the received degree of parallelism information, the CPE 21 can determine how many PEs 22 can execute the processing program at which operating frequency.

In a method of the determination, according to a basis of minimizing the power consumption of the AC 19, optimal PEs 22 to be operated and an optimal operating frequency are determined. Moreover, the PEs 22 which are not used for the process are controlled to minimize the power consumption, for example, the supply of the power thereto is stopped.

The CPE 21 determines the operating frequency and the supply voltage of each of the determined one or more PEs 22 to be operated (step T13). In other words, the CPE 21 determines the operating frequency and the supply voltage of each of the operating PEs 22, and controls the F/V control unit 22c to supply the clock signal corresponding to the determined operating frequency and the power of the determined voltage to each of the operating PEs 22. It should be noted that the clock signal is not supplied and also the power required for the calculation process is not supplied with respect to non-operating PEs.

For example, the determination of the operating frequency at step T13 is performed as described below. FIG. 19 is a flowchart showing an example of a flow of a process of determining the operating frequency.

First, the CPE 21 determines the PE 22 which is currently available (step T21). In other words, when the instruction for the process is received, there may be a PE 22 already executing another process among the PEs 22 of the AC 19. The CPE 21 is monitoring the operation of each PE 22, and can grasp what process each PE 22 is executing. Thus, before requesting the process, the CPE 21 first determines which PE 22 can execute the process and determines the available, that is, executable PE 22 (step T21).

Next, the CPE 21 determines the operating frequency and the supply voltage depending on the load, and notifies the operating frequency and the supply voltage to each F/V control unit 22c of each PE 22 (step T22). For example, like the program A shown in the table of FIG. 17, in the case of the processing program with the load of 2 and the degree of parallelism of 4, if there are three executable PEs at step T21, assuming that a maximum operable frequency of each calculation unit 22a is f, the CPE 21 performs a process of dividing 2 showing the load of the program by 3 showing the number of the executable PEs 22. Then, a value of a result of the division (⅔) is obtained. Consequently, the operating frequency of the calculation unit 22a of the PE 22 becomes (⅔)f.

It should be noted that the operating frequency of the PE 22 may not be able to take the value of the division result, for example, in a case where the PE 22 is operable only at a frequency of a previously fixed value such as f, (½)f, (⅓)f, (¼)f, (⅛)f and the like as the operating frequency. In such a case, the CPE 21 selects and determines a value which is close to (⅔)f and more than (⅔)f, as the operating frequency.

In this way, the CPE 21 determines the operating frequency of the PE 22 to be operated and further determines the supply voltage of the operating PE 22. The supply voltage is a voltage required for the operation, with respect to the PE 22 to be operated. With respect to the non-operating PE 22, the voltage required for the operation is not supplied, and the supply voltage becomes 0 or a voltage corresponding to minimum power consumption such as a standby state.

Returning to FIG. 18, the CPE 21 instructs the operating PE 22 to load the processing program (the image recognition program in the above described example) (step T14). Specifically, the CPE 21 notifies the address of the processing program to the PE 22, and instructs the PE 22 to load the processing program, that is, outputs a load instruction for the processing program. Consequently, the operating PE 22 loads the processing program and stores the processing program in the local memory 22b.

Then, the CPE 21 outputs a start instruction with respect to the operating PE 22 (step T15). When the PE 22 receives the start instruction, the PE 22 executes the processing program accumulated in the local memory 22b. At this time, the calculation unit 22a of each PE 22 is operating based on the operating frequency and the voltage notified and set to the F/V control unit 22c.

The PE 22 outputs the result data of the process to the address instructed at step T2.

The CPE 21 monitors the operation of each PE, and when all processes are completed, the CPE 21 executes the predetermined process.

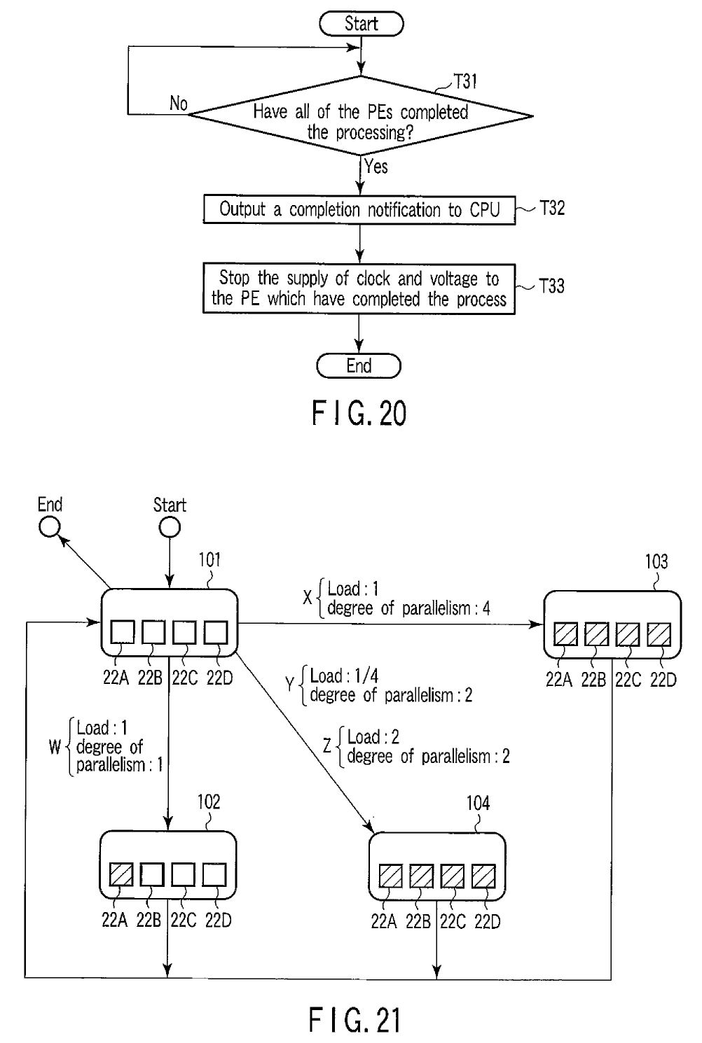

FIG. 20 is a flowchart showing an example of a flow of the process at the time of completing the processing program in the calculation unit 21a of the CPE 21.

The CPE 21 monitors an execution state of the processing program in each PE 22, and first determines whether or not all PEs 22 to which an operation instruction of executing the processing program has been issued, have completed the process (step T31).

When all PEs 22 have completed the process, the CPE 21 outputs a completion notification showing that the execution of the requested processing program has been completed, to the CPU 11 (step T32).

Then, the CPE 21 stops the supply of the clock signal of the operating frequency and the voltage determined at step S13, to the PE 22 which has completed the process (step T33). The stop means that the supply is set to a supply state of the clock signal of the operating frequency and the voltage in the so-called standby state.

As described above, the processing program is requested from the CPU 181 with respect to the AC 19, and executed in the AC 19.

Next, the flow of the process as described above will be described by using a specific example. FIG. 21 is a diagram illustrating the process in the CPE 21. FIG. 21 shows an example of change in a state of the AC 19, and shows that the four PEs 22 are included. It should be noted that, in FIG. 21, a node Start shows a state before the CPE 21 operates, and a node End shows a state where the CPE 21 has completed the operation. When the CPE 21 starts the operation, the state becomes a standby state 101.

In FIG. 21, when the AC 19 is in the standby state 101, and the AC 19 in the standby state 101 is requested for a process W with the load of 1 and the degree of parallelism of 1 from the CPU 181, the state becomes a state 102.

In the standby state 101, within the AC 19, the clock gating is performed and the supply of the clock signal is stopped with respect to a circuit part to which the gating can be performed, and the clock signal having the frequency which has been lowered to a lowest possible level is supplied with respect to a circuit part in which the frequency of the clock signal can be lowered. Thus, the standby state 101 is a state of the minimum power consumption of the AC 19.

In the standby state 101, when the process W as described above is requested, the CPE 21 finds that the process W is a process with the load of 1 which can be processed by one PE 22 and the degree of parallelism of 1, and in that case, the CPE 21 sets one PE 22A as the PE to be operated, also sets the operating frequency of the PE 22A to the maximum operating frequency f, performs the clock gating and stops the supply of the power with respect to the other PEs 22B, 22C and 22D. It should be noted that a shaded PE 22A among the four PEs 22 is the operating PE in FIG. 21.

After the process W has been completed, the state returns from the state 102 to the standby state 101. Furthermore, when the AC 19 is in the standby state 101, and the AC 19 in the standby state 101 is requested for a process X with the load of 1 and the degree of parallelism of 4 from the CPU 181, the state becomes a state 103.

Specifically, when the process X as described above is requested, the CPE 21 finds that the process X is a process with the load of 1 which can be processed by one PE 22 and the degree of parallelism of 4. When an operating method with the minimum power consumption is a method configured to evenly share the load among multiple operable PEs 22, the CPE 21 sets all four PEs 22 as the PEs to be operated, also sets the operating frequency of each PE 22 to (¼)f (f is the maximum operating frequency), and causes the PEs 22 to operate.

It should be noted that, in the case of the process X with the load of 1 and the degree of parallelism of 4, there are also other options including a method configured to execute the process by one PE at the operating frequency of (1/1)f and a method configured to execute the process by two PEs at the operating frequency of (½)f. However, the optimal method, that is, the method with low power consumption to be determined varies depending on an implementation method, an operation method and the like of each circuit in the AC 19.

After the process X has been completed, the state returns from the state 103 to the standby state 101. Furthermore, when the AC 19 is in the standby state 101, and the AC 19 in the standby state 101 is requested for two processes, that is, a process Y with the load of ¼ and the degree of parallelism of 2 and a process Z with the load of 2 and the degree of parallelism of 2 from the CPU 181, the state becomes a state 104.

Specifically, when the processes Y and Z as described above are requested, the CPE 21 finds that the process Y has (¼) of the load which can be processed by one PE 22 and the degree of parallelism of 2. Also, the CPE 21 finds that the process Z has the load of 2 which can be processed by two PEs 22 and the degree of parallelism of 2. Therefore, when the operating method with the minimum power consumption is the method configured to evenly share the load among the multiple operable PEs 22, with respect to the process Y, the CPE 21 sets two PEs 22A and 22B as the PEs to be operated, also sets the operating frequency to (⅛)f and causes the PEs 22A and 22B to operate to perform the process Y. Also, with respect to the process Z, the CPE 21 sets two PEs 22C and 22D as the PEs to be operated, also sets the operating frequency to (1/1)f and causes the PEs 22C and 22D to operate to perform the process Z. In that case, the program of the process Y is loaded to the PEs 22A and 22B, and the program of the process Z is loaded to the PEs 22C and 22D.

After the processes Y and Z have been completed, the state returns from the state 104 to the standby state 101.

As described above, in the AC 19, depending on the processing program, the operation of each PE 22 is controlled so that the power consumption is optimized, that is, here the power consumption becomes low. Consequently, the power consumption in the AC 19 is controlled to dynamically change. In other words, in the AC 19, depending on the load of the processing program, the provision of the calculation unit 22a which is the internal calculation resource and its operating state are dynamically changed. Then, with respect to the calculation unit 22a of each operating PE 22, the operating frequency and the supply voltage are determined so that the power consumption is optimized in the AC 19. With respect to each non-operating PE 22, the clock gating, the stop of the supply of the voltage and the like are performed. Consequently, in the PE 22 which is not used, the power consumption due to the clock signal or occurrence of the internal leak current is reduced to be low, which can reduce useless power consumption.

Thus, according to the present embodiment, since the AC 19 autonomously determines the sharing of the process among the multiple PEs 22 therein, also determines the operation and the processing capability in consideration of the power consumption, and executes the process requested by the CPU 181, the AC 19 can perform the requested process with the optimal power consumption.

### Fifth Embodiment

Next, a fifth embodiment of the present invention will be described. The AC for the information processing device according to the fifth embodiment has not only the multiple general purpose processing units (PEs) but also multiple hard macros, and also determines the sharing of the process and controls to execute the process with the optimal power consumption with respect to operations of the multiple hard macros.

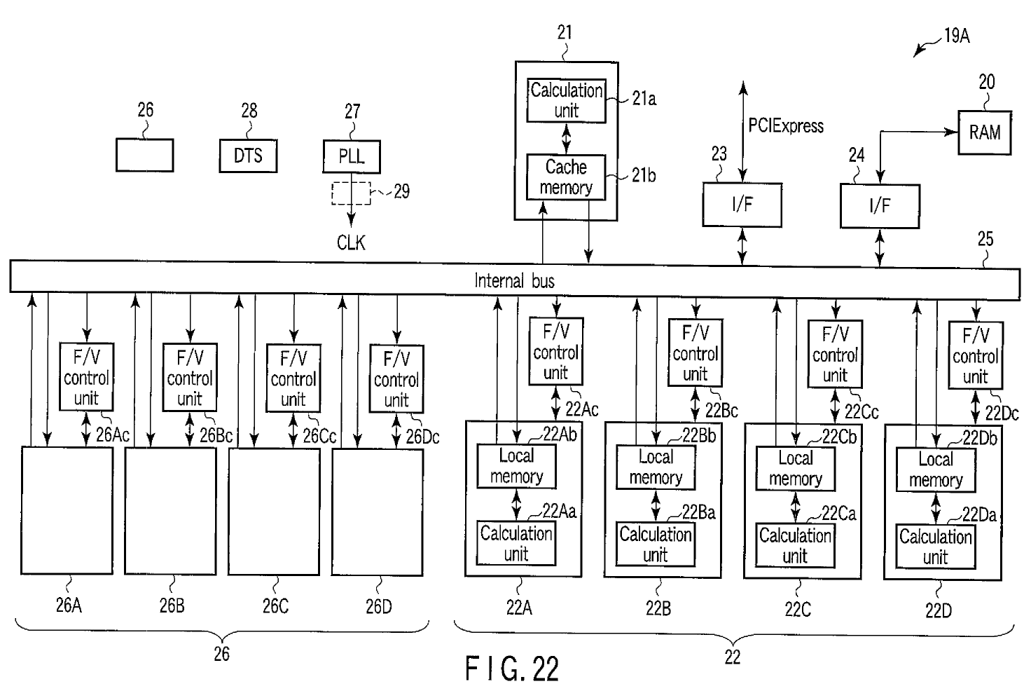

FIG. 22 is a block diagram showing a configuration of an AC 19A according to the fifth embodiment. Same components as the AC 19 of the fourth embodiment are attached with same reference characters and descriptions thereof are omitted.

As shown in FIG. 22, the AC 19A has multiple (here, two) encoders 26A and 268 and multiple (here, two) decoders 26C and 26D as the hard macros, which are connected to the CPE 21 via the internal bus 25, respectively. Hereinafter, the encoders 26A and 26B and the decoders 26C and 26D will be collectively referred to as “hard macro 26”, or one of them will be referred to as “hard macro 26”.

The hard macro 26 is a hardware engine unit, and is not such a general purpose processing unit as the PE 22 which can execute the received program. The PE 22 is the general purpose processing unit which can execute the process depending on the program, whereas contents of a process in the hard macro 26 are realized by hardware such as an ASIC, in which the process is executed when control data for the operation and the target data are given.

In the present embodiment, it is assumed that the AC 19A is configured so that the AC 19A can execute two processes, that is, an encoding process and a decoding process for the image data in image processes in MPEG4, H264, VC1 and the like, by the hard macro 26. The two encoders 26A and 26B are hardware circuits capable of processing the encoding process in parallel based on the request from the CPE 21. Also, the two decoders 26C and 26D are hardware circuits capable of processing the decoding process in parallel based on the request from the CPE 21.

Therefore, the AC 19A can execute the encoding or decoding process, or both of the encoding and decoding processes, by using the hard macro 26 capable of processing each process in parallel, separately from the process in the PE 22.

Moreover, the encoders 26A and 26B and the decoders 26C and 26D are provided with F/V control units 26Ac, 26Bc, 26Cc and 26Dc (hereinafter collectively referred to as “F/V control unit 26c”, or one F/V control unit will be referred to as “F/V control unit 26c”), respectively. Each F/V control unit 26c is an operation control unit configured to control both the operation and a processing capability of the corresponding hard macro 26, and specifically, is a circuit having a function configured to change the frequency of the clock signal supplied to the corresponding hard macro 26, a function configured to supply and stop the clock signal supplied to each circuit in the hard macro 26, and a function configured to supply and stop the power supplied to each circuit in the hard macro 26.

Thus, when the application program is executed in the information processing device 1, the change of the frequency of the clock signal, the supply and the stop of the clock signal, and the supply and the stop of the power are performed under the control of the CPE 21, depending on usage states of the encoders 26A and 26B and the decoders 26C and 26D, or depending on whether or not to use the encoders 26A and 26B and the decoders 26C and 26D.

It should be noted that, also in the present embodiment, although the F/V control unit 26c is provided for each of the encoders 26A and 26B and the decoders 26C and 26D, one F/V control unit 26c may be provided with respect to the whole of the encoders 26A and 26B and the decoders 26C and 26D, and the change of the frequency of the clock signal, the supply and the stop of the clock signal, and the supply and the stop of the power may be performed with respect to the whole thereof. Also in that case, similarly to the fourth embodiment, the output of the PLL circuit 27 is outputted via the switching circuit 29, and the control signal configured to stop the supply of the clock is supplied with respect to the switching circuit 29 from the CPE 21.

The respective functions are equal to the functions with respect to the PE 22 described in the fourth embodiment.

It should be noted that, also in the present embodiment, although each F/V control unit 26c controls both the operation and the processing capability of the corresponding hard macro 26, each F/V control unit 26c may control at least one of the operation and the processing capability.

Then, the calculation unit 21a of the CPE 21 controls each PE 22, each hard macro 26 and each of the F/V control units 22c and 26c, as will be described later. Thus, the control of the operation and the processing capability of the calculation unit 22a by each F/V control unit 22c, and the control of the operation and the processing capability of the hard macro 26 by each F/V control unit 26c are performed in response to the instruction from the calculation unit 21a of the CPE 21.

When the calculation unit 21a which is the control unit receives the command of executing the predetermined process from the CPU 181, the calculation unit 21a outputs a predetermined instruction with respect to the four PEs 22 and the four hard macros 26, depending on the command. The predetermined instruction includes an instruction on which PE 22 or which hard macro 26 executes the process, an instruction on which operating frequency is provided at that time, and the like.

Hereinafter, the operation of the AC 19A will be described, for example, in the case where the AC 19A performs the decoding process and the image recognition process for the image data, with respect to image data captured and obtained by the camera or the like. It should be noted that the image recognition process and the decoding process may be simultaneously performed or may not be simultaneously performed, and further may be performed in synchronization with each other or asynchronously.

Similarly to the fourth embodiment, if the CPU 181 requests and causes the AC 19A to perform the image recognition application program, the CPU 181 outputs the predetermined command with respect to the AC 19A. The AC 19A receives the command and performs the process of the application program specified by the CPU 181. In that case, the image recognition application program is executed in the PE 22, and the operation of the PE 22 based on the load information and the degree of parallelism information in that case is similar to the operation in the fourth embodiment. In other words, based on the load information and the degree of parallelism information on the image processing program, the CPE 21 determines the operations of the multiple PEs 22.

The flow of the process in the CPU 181 in that case is similar to FIGS. 16 and 17. In other words, the CPU 181 transmits the image recognition program to the AC 19A, and the calculation unit 21a of the CPE 21 stores the image recognition program from the CPU 181 in the RAM 20. Then, the CPU 181 transmits the address of the target data which is the target of the image recognition process, the address of the result data of the recognition process, the load information on the image recognition program, and the degree of parallelism information on the image recognition program to the AC 19A. The AC 19A accumulates the received load information and the received degree of parallelism information in the RAM 20.

On the other hand, if the CPU 181 requests and causes the AC 19A to perform the decoding process for the image data, the CPU 181 outputs a predetermined command, which is different from the above described command for the image recognition process, with respect to the AC 19A. It should be noted that the CPU 181 may request the decoding process for the image data simultaneously with the above described request for the image recognition process, or separately from the above described request for the image recognition process. The AC 19A receives the command and performs the decoding process specified by the CPU 181, by using the hard macro 26.

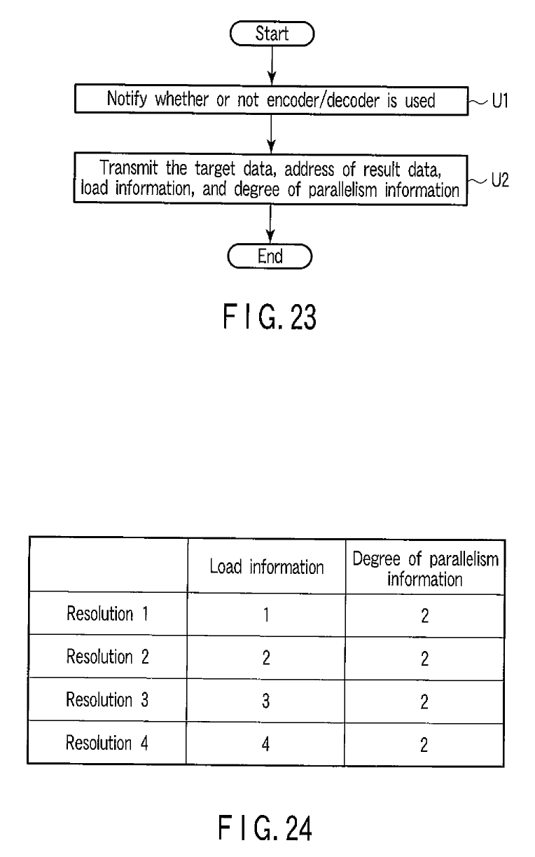

FIG. 23 is a flowchart showing an example of the flow of the process in the CPU 181 in that case.

If the CPU 181 causes the AC 19A to share the decoding process for the image data, the CPU 181 notifies whether or not to use the decoders 26C and 26D to the AC 19A (step U1). Since the CPU 181 requests the decoding process, the CPU 181 notifies that the decoders 26C and 26D are used, and consequently, it means that the CPU 181 has notified that the encoders 26A and 26B are not used.

Next, similarly to the case of FIG. 16, the CPU 181 transmits the address of the target data, the address of the result data, the load information, and the degree of parallelism information to the AC 19A (step U2). Here, the target data is target data of the decoding process, the result data is result data of the decoding process, the load information is load information on the target data of the decoding process, and the degree of parallelism information is degree of parallelism information on the decoding process. Here, the load information is determined depending on a resolution, a profile and the like of the image data which is the target data, because, for example, the load of the process becomes large when the resolution is high, and the load becomes small when the resolution is low. The AC 19A accumulates the received load information and the received degree of parallelism information in the RAM 20.

FIG. 24 is a diagram showing an example of table data showing the load information and the degree of parallelism information on the decoding process. As shown in FIG. 24, depending on a level of the resolution of the image data, the load information and the degree of parallelism information have been previously set. Although not shown, table data similar to FIG. 24 has also been prepared with respect to the encoding process.

Since the process of the image recognition program in the CPE 21 is similar to FIGS. 18 to 20 in the fourth embodiment, a description thereof is omitted.

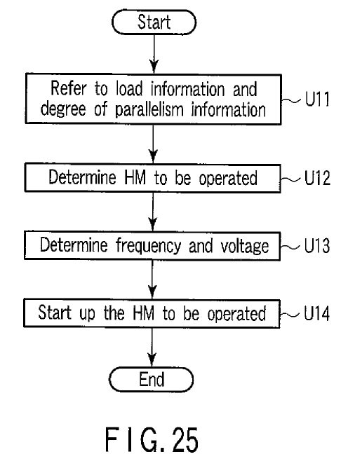

The decoding process will be described by using FIG. 25. FIG. 25 is a flowchart showing an example of the decoding process in the CPE 21.

When the above described decoding process is requested from the CPU 181, the CPE 21 refers to the received load information and the received degree of parallelism information, and stores the load information and the degree of parallelism information in the RAM 20 (step U11).

The CPE 21 determines the hard macro (HM) to be operated, based on the load information and the degree of parallelism information (step U12). In other words, the CPE 21 couples the load information with the degree of parallelism information to determine one or more hard macros (HMs) to be operated, and the number of operating hard macros 26 is determined.

Here, since the requested process is the decoding process, the two decoders 26C and 26D are available, and if the degree of parallelism information is “2”, the two hard macros 26C and 26D are determined as the operating hard macros.

Then, similarly to the fourth embodiment, based on the received load information and the received degree of parallelism information, the CPE 21 can determine at which operating frequency each hard macro 26 can execute the process. Furthermore, if there is any hard macro which does not perform the decoding process, such a hard macro 26 is controlled to minimize the power consumption, for example, the supply of the power thereto is stopped.

Therefore, the CPE 21 determines the operating frequency and the supply voltage of each of the determined one or more hard macros 26 to be operated (step U13). Thus, the clock signal is not supplied and also the power required for the calculation process is not supplied with respect to non-operating hard macros 26. Since a method configured to determine the operating frequency and the supply voltage depending on the load with respect to the hard macro 26 at step U13 is the same as the method configured to determine the operating frequency and the supply voltage depending on load power with respect to the PE 22 which has been described in FIG. 19 of the fourth embodiment, a description thereof is omitted.

Next, the CPE 21 outputs the start instruction with respect to the operating hard macro (HM) 26 (step S25). When the hard macro (HM) 26 receives the start instruction, the hard macro (HM) 26 reads and obtains the target data of the decoding process from the specified address, applies the decoding process to the target data, and outputs the result data of the decoding process to the specified address. At this time, each hard macro 26 is operating according to the operating frequency and the voltage notified and set to the F/V control unit 26c.

As described above, in addition to the multiple general purpose processing units, the AC 19A has the multiple hard macros, and the CPE 21 determines the operations of the multiple hard macros, based on the load information and the degree of parallelism information on the data to be processed.

Thus, according to the present embodiment, since the AC 19A autonomously determines the sharing of the process among the multiple PEs 22 and the multiple hard macros 26 therein, also determines the operation and the processing capability in consideration of the power consumption, and executes the process requested by the CPU 181, the AC 19A can perform the requested process with the optimal power consumption.

It should be noted that, in the above described example, although an example in which the processes performed by the hard macro are the encoding and the decoding of the image data has been described, in addition, for example, the process may be a physical simulation process (a process of simulating a physical phenomenon in a virtual space), a WIFI communication process, an encryption operation (coding/decryption) process and the like.

As described above, according to the above described embodiments, it is possible to realize the accelerator and the information processing device in which the accelerator having the multiple calculation units which can execute the program by processing the program in parallel and can determine the sharing among the multiple calculation units in the accelerator itself to execute the program.

The present invention is not limited to the above described embodiments, and various modifications, alterations and the like are possible within a range not changing the gist of the present invention.

### Sixth Embodiment

In a sixth embodiment, examples of aspects of the fourth and fifth embodiment of the invention will be explained.

<A First Aspect>

In the first aspect, an accelerator operable to be coupled to an information processing device and execute a program comprises a plurality of calculation units, an operation control unit, and a control unit.

Each calculation unit is operable to execute a program in parallel.

The operation control unit controls an operation capability or a processing capability for each of the plurality of calculation units.

The control unit determines a corresponding operation capability or processing capability for each of the plurality of calculation units based on load information associated with the program and controls the operation control unit based on the determination. The operation control unit is controlled such that each of the plurality of calculation units operates according to the corresponding operation capability or processing capability during execution of the program.

<A Second Aspect>

In a second aspect, the control unit according to the first aspect determines the corresponding operation capability or processing capability for each of the plurality of calculation units based on degree of parallelism information associated with the program.

<A Third Aspect>

In the third aspect, the control unit according to the second aspect determines one or more of the plurality of calculation units to be operated during execution of the program and further determines the processing capability of each of the one or more of the plurality of calculation units based on the number of the one or more of the plurality of calculation units to be operated during the execution of the program and the load information associated with the program.

<A Fourth Aspect>

In the fourth aspect, the control unit according to the third aspect determines the processing capability corresponding to each of the one or more of the plurality of calculation units to be operated by dividing a load corresponding to the load information associated with the program by the number of the one or more of the plurality of calculation units to be operated during execution of the program.

<A Fifth Aspect>

In the fifth aspect, the processing capability of the fourth aspect corresponds to an operating frequency associated with each of the plurality of calculation units. The operation control unit of the fourth aspect controls the processing capability of the plurality of calculation units by controlling the operating frequency of each of the plurality of calculation units.

<A Sixth Aspect>

In the sixth aspect, the operating frequency of the fifth aspect is selected from one of a set of operating frequencies. The selected operating frequency is the operating frequency of the set of operating frequencies closest to a fraction of a maximum operating frequency. The fraction is determined by dividing the load corresponding to the load information associated with the program by the number of the one or more of the plurality of calculation units to be operated during execution of the program.

<A Seventh Aspect>

In the seventh aspect, the operation control unit of the first aspect is operable to control the operation of each of the plurality of calculation units by controlling a supply of power to each of the plurality of calculation units.

<A Eighth Aspect>

In the eighth aspect, an information processing device comprises an accelerator operable to execute a program and a computing device coupled to the accelerator.

The accelerator includes a plurality of calculation units, an operation control unit, and a control unit.

Each calculation unit is operable to execute a program in parallel.

The operation control unit controls an operation capability or a processing capability for each of the plurality of calculation units.

The control unit determines a corresponding operation capability or processing capability for each of the plurality of calculation units based on load information associated with the program and controls the operation control unit based on the determination.

The operation control unit is controlled such that each of the plurality of calculation units operates according to the corresponding operation capability or processing capability during execution of the program.

<A Ninth Aspect>

In the ninth aspect, the computing device of the eighth aspect has a PC architecture.

<A Tenth Aspect>

In the tenth aspect, the computing device of the ninth aspect includes a Central Processing Unit and a Graphics Processing Unit.

<A Eleventh Aspect>

In the eleventh aspect, an accelerator operable to be coupled to an information processing device comprises a plurality of calculation units, a plurality of hardware engine units, an operation control unit, and a control unit.

Each calculation unit is operable to execute a program in parallel.

Each hardware engine unit is operable to execute a predetermined process with respect to target data. Each hardware engine unit is operable to execute the predetermined process in parallel.

The operation control unit controls an operation capability or a processing capability for each of the plurality of calculation units and the plurality of hardware engine units.

The control unit determines a corresponding operation capability or processing capability for each of the plurality of calculation units based on first load information associated with the program, determines a corresponding operation capability or processing capability for each of the plurality of hardware engine units based on second load information associated with the target data, and controls the operation control unit depending on these determinations.

The operation control unit is controlled such that each of the plurality of calculation units operates according to the corresponding operation capability or processing capability during execution of the program

Each of the plurality of hardware engine units operates according to the corresponding operation capability or processing capability during execution of the predetermined process with respect to the target data.

<A Twelfth Aspect>

In the twelfth aspect, the control unit of the eleventh aspect determines the corresponding operation capability or processing capability for each of the plurality of calculation units based on degree of parallelism information associated with the program, and determines the corresponding operation capability or processing capability for each of the plurality of hardware engine units based on the degree of parallelism information associated with the target data.

<A Thirteenth Aspect>

In the thirteenth aspect, the control unit of the twelfth aspect determines one or more of the plurality of calculation units to be operated during execution of the program, determines the processing capability of each of the one or more of the plurality of calculation units based on the number of the one or more of the plurality of calculation units to be operated during the execution of the program and the first load information associated with the program, determines one or more of the plurality of hardware engine units to be operated, and determines the processing capability of each of the one or more of the plurality of hardware engine units based on the number of the one or more of the plurality of hardware engine units to be operated and the second load information associated with the target data.

<A Fourteenth Aspect>

In the fourteenth aspect, the control unit of the thirteenth aspect determines the processing capability corresponding to each of the one or more of the plurality of calculation units to be operated by dividing a first load corresponding to the first load information associated with the program by the number of the one or more of the plurality of calculation units to be operated during execution of the program, and determines the processing capability corresponding to each of the one or more of the plurality of hardware engine units to be operated by dividing a second load corresponding to the second load information associated with the target data by the number of the one or more of the plurality of hardware engine units to be operated.

<A Fifteenth Aspect>

In the fifteenth aspect, the processing capability of the eleventh aspect corresponds to a first operating frequency associated with each of the plurality of calculation units and a second operating frequency associated with each of the plurality of hardware engine units.

The operation control unit of the eleventh aspect controls the processing capability of the plurality of calculation units and the plurality of hardware engine units by controlling the first operating frequency of each of the plurality of calculation units and the second operating frequency of each of the plurality of hardware engine units.

<A Sixteenth Aspect>

In the sixteenth aspect, the first operating frequency of the fifteenth aspect for the plurality of calculation units is selected from one of a set of operating frequencies for the plurality of calculation units and the selected first operating frequency is the operating frequency of the set of operating frequencies for the plurality of calculation units closest to a first fraction of a first maximum operating frequency. The first fraction is determined by dividing the first load corresponding to the first load information associated with the program by the number of the one or more of the plurality of calculation units to be operated during execution of the program.

The second operating frequency of the fifteenth aspect for the plurality of hardware engine units is selected from one of a set of operating frequencies for the plurality of hardware engine units and the selected second operating frequency is the operating frequency of the set of operating frequencies for the plurality of hardware engine units closest to a second fraction of a second maximum operating frequency. The second fraction is determined by dividing the load corresponding to the second load information associated with the target data by the number of the one or more of the plurality of hardware engine units to be operated.

<A Seventeenth Aspect>

In the seventeenth aspect, the operation control unit of the eleventh aspect is operable to control the operation of each of the plurality of calculation units and each of the plurality of hardware engine units by controlling a supply of power to each of the plurality of calculation units and plurality of hardware engine units.

<A Eighteenth Aspect>

In the eighteenth aspect, an information processing device comprises an accelerator operable to execute a program and a computing device coupled to the accelerator.

The accelerator includes a plurality of calculation units, a plurality of hardware engine units, an operation control unit, and a control unit.

Each calculation unit is operable to execute a program in parallel.

Each hardware engine unit is operable to execute a predetermined process with respect to target data. Each hardware engine unit is operable to execute the predetermined process in parallel.

The operation control unit controls an operation capability or a processing capability for each of the plurality of calculation units and each of the plurality of hardware engine units.

The control unit determines a corresponding operation capability or processing capability for each of the plurality of calculation units based on first load information associated with the program, determines a corresponding operation capability or processing capability for each of the plurality of hardware engine units based on second load information associated with the target data and control the operation control unit depending on these determinations. The operation control unit is controlled such that each of the plurality of calculation units operates according to the corresponding operation capability or processing capability during execution of the program and each of the plurality of hardware engine units operate according to the corresponding operation capability or processing capability during execution of the predetermined process with respect to the target data.

<A Nineteenth Aspect>

In the nineteenth aspect the computing device of the eighteenth aspect has a PC architecture.

<A Twentieth Aspect>

In the twentieth aspect, the computing device of the nineteenth aspect includes a Central Processing Unit and a Graphics Processing Unit.

<A Twenty-First Aspect>

In the twenty-first aspect, an information processing method comprises determining a corresponding operation capability or processing capability for each of a plurality of calculation units of an accelerator based on load information on a program to be executed by the accelerator wherein each calculation unit is operable to execute the program in parallel and determining a corresponding operation capability or processing capability for each of the plurality of calculation units is based on load information associated with the program, and controlling each of the plurality of calculation units during execution of the program such that each of the plurality of calculation units operates according to the corresponding operation capability or processing capability during execution of the program.

<A Twenty-Second Aspect>

In the twenty-second aspect, the corresponding operation capability of the twenty-first aspect or processing capability of the twenty-first aspect for each of the plurality of calculation units is determined based on degree of parallelism information associated with the program.

<A Twenty-Third Aspect>

In the twenty-third aspect, the information processing method according to the twenty-second aspect further comprises determining one or more of the plurality of calculation units to be operated during execution of the program, and determining the processing capability of each of the one or more of the plurality of calculation units based on the number of the one or more of the plurality of calculation units to be operated during the execution of the program and the load information associated with the program.

<A Twenty-Fourth Aspect>

In the twenty-fourth aspect, the processing capability of the twenty-third aspect corresponding to each of the one or more of the plurality of calculation units to be operated is determined by dividing a load corresponding to the load information associated with the program by the number of the one or more of the plurality of calculation units to be operated during execution of the program.

<A Twenty-Fifth Aspect>

In the twenty-fifth aspect, the processing capability of the twenty-first aspect corresponds to an operating frequency associated with each of the plurality of calculation units. The operation control unit of the twenty-first aspect controls the processing capability of the plurality of calculation units by controlling the operating frequency of each of the plurality of calculation units.

What is claimed is:

1. A multiprocessor control device comprising:
a selection unit which, on the basis of an execution schedule for a plurality of tasks to be allocated to any one of a plurality of processor elements, selects, for each of the plurality of processor elements, any one of a normal mode used in a task execution time, a first mode which is used when a task is not executed and in which an electric power consumption is reduced more than in the normal mode, and a second mode which is used when the task is not executed and which has a greater electric power consumption reducing effect but a longer mode switching time than the first mode; and
a mode control unit which performs control according to the mode selected by the selection unit for each of the plurality of processor elements.

2. The multiprocessor control device according to claim 1, wherein the selection unit selects, for each of the plurality of processor elements, the normal mode during the task execution time and, when the time from the completion of a task execution until the start of a next task execution is included in a first mode applicable time range, the first mode during the time from the completion of the task execution until the start of the next task execution and, when the time from the completion of the task execution until the start of the next task execution exceeds the first mode applicable time range, the second mode during the time from the completion of the task execution until the start of the next task execution, and the normal mode during the next task execution time.

3. The multiprocessor control device according to claim 1, wherein the selection unit, when selecting the second mode, determines an execution time of the second mode so that a value added a mode switching time to the execution time of the second mode is not exceed the time from the completion of the task execution until the start of the next task execution, and
the mode control unit outputs an instruction to execute the second mode according to the execution time of the second mode determined by the selection unit.

4. The multiprocessor control device according to claim 1, wherein the execution schedule is so created that the plurality of tasks which need not be executed in parallel are preferentially allocated to specific one of the plurality of processor elements.

5. The multiprocessor control device according to claim 1, wherein the first mode is a Rest mode, and
the second mode is a Sleep mode.

6. The multiprocessor control device according to claim 1, wherein the first mode is a mode in which at least one of stopping a supply of a clock signal to a processor element to be controlled, decreasing the frequency of the clock signal, and lowering a voltage of electric power supplied to the processor element to be controlled is performed, and
the second mode is a mode in which a supply of electric power to the processor element to be controlled is stopped.

7. The multiprocessor control device according to claim 1, wherein the first mode includes a plurality of Rest modes differing in a electric power consumption suppressing effect.

8. The multiprocessor control device according to claim 7, wherein the plurality of Rest modes differ in a combination of stopping a supply of a clock signal to a processor element to be controlled, decreasing the frequency of the clock signal, and lowering a voltage of electric power supplied to the processor element to be controlled.

9. The multiprocessor control device according to claim 1, further comprising a schedule management unit which manages a job input schedule for the plurality of processor elements and adjusts an execution schedule for the plurality of tasks.

10. A multiprocessor control method comprising:
on the basis of an execution schedule for a plurality of tasks to be allocated to any one of a plurality of processor elements, selecting, for each of the plurality of processor elements, any one of a normal mode used in a task execution time, a first mode which is used when a task is not executed and in which an electric power consumption is reduced more than in the normal mode, and a second mode which is used when the task is not executed and which has a greater electric power consumption reducing effect but a longer mode switching time than the first mode; and
performing control according to a selected mode for each of the plurality of processor elements.

11. The multiprocessor control method according to claim 10, wherein the selecting includes selecting, for each of the plurality of processor elements, the normal mode during the task execution time and, when the time from the completion of a task execution until the start of a next task execution is included in a first mode applicable time range, the first mode during the time from the completion of the task execution until the start of the next task execution and, when the time from the completion of the task execution until the start of the next task execution exceeds the first mode applicable time range, the second mode during the time from the completion of the task execution until the start of the next task execution, and the normal mode during the next task execution time.

12. The multiprocessor control method according to claim 10, wherein the selecting includes, when selecting the second mode, determining an execution time of the second mode so that a value added a mode switching time to the execution time of the second mode is not exceed the time from the completion of the task execution until the start of the next task execution, and
the performing control includes outputting an instruction to execute the second mode according to the determined execution time of the second mode.

13. The multiprocessor control method according to claim 10, wherein the execution schedule is so created that the plurality of tasks which need not be executed in parallel are preferentially allocated to specific one of the plurality of processor elements.

14. The multiprocessor control method according to claim 10, wherein the first mode is a Rest mode, and
the second mode is a Sleep mode.

15. The multiprocessor control method according to claim 10, wherein the first mode is a mode in which at least one of stopping a supply of a clock signal to a processor element to be controlled, decreasing the frequency of the clock signal, and lowering a voltage of electric power supplied to the processor element to be controlled is performed, and
the second mode is a mode in which a supply of electric power to the processor element to be controlled is stopped.

16. The multiprocessor control method according to claim 10, wherein the first mode includes a plurality of Rest modes differing in a electric power consumption suppressing effect.

17. The multiprocessor control method according to claim 16, wherein the plurality of Rest modes differ in a combination of stopping a supply of a clock signal to a processor element to be controlled, decreasing the frequency of the clock signal, and lowering a voltage of electric power supplied to the processor element to be controlled.

18. The multiprocessor control method according to claim 10, further comprising managing a job input schedule for the plurality of processor elements and adjusts an execution schedule for the plurality of tasks.
